(19) United States
(12) Patent Application Publication
(10) Pub. No.: US 2008/0167120 A1
(43) Pub. Date: Jul. 10, 2008

(54) Interactive entertainment

(75) Inventors: Michael Spyres, Herts (GB); Adrian Michael Wildsmith, Herts (GB)

Correspondence Address: Paul D. Greeley;Ohlandt, Greeley, Ruggiero & Perle, L.L.P., 10th Floor, One Landmark Square, Stamford, CT, 06901-2682, US

(73) Assignee: Cloudcity Games Plc.,

(21) Appl. No.: 11/986,440

(22) Filed: Nov. 21, 2007

(30) Foreign Application Priority Data
Nov. 22, 2006 (GB) 0623312.6

(51) Int. Cl. G06F 17/00

(52) U.S. Cl. 463/25; 463/42

(57) ABSTRACT

An on line entertainment system is provided which involves one or more servers and client stations for the provision of games whereby the interaction between the player and the game server results in the production of various screen shots on the players display which provide the ability for the player to decide whether to participate in a game and enables the player to select both the nature of the game and method of game play.

The present invention relates to interactive entertainment systems that select questions for testing knowledge and provide the ability for an individual to test their knowledge in various environments including an individual environment and in competition with others. The system also allows participants to place a stake on the correctness of their answer to a question and also to employ a variety of methods of staking according to the individual preference. In addition the invention relates to systems which enable multiple users located anywhere in the world to simultaneously test their knowledge against the same question or series of questions in their choice of format. The system with or without staking can be used for entertainment purposes and the interaction between the user and the game server and the execution of the underlying software results in the production of various screen shots on the user's display. Furthermore, during the playing of the game when a staking process is involved, a financial credit or debit is made to the user's account and a report may be provided either electronically or in hardcopy.

The system may also be used for educational purposes.

The present invention operates interactively with on line client work-stations interacting with one or more games servers preferably via an internet web site.

The embodiment of the present invention which allows a participant to place a stake on the correctness of the answers to the questions involves a financial system which is integrated with the game play system through the interaction between the game sever and the underlying financial software. The financial system preferably provides automatic real time credit management, real time transaction confirmation, a credit management tracking system and player auditing, coupled with an appropriate security system. The game play system is integrated with a synchronised question provision system. Other features of the present invention could include choice of currencies and languages.

In a further embodiment the present invention includes a calendaring system whereby the timing of the provision of games around the world can be correlated. The method of play can then go hand in hand with a calendar and various staking structures to provide a full range of opportunities including the different types of games, and game play, that are available. In this way the availability of the category or type, subject and nature of a question and game available can be made known to the participant in a readily accessible manner that is easy to navigate to accommodate the requirements of the individual.

In one embodiment the invention is therefore an integration and synchronisation of the question delivery system which is the subject of our co-filed patent application reference PACLBA605 to allow for the simultaneous delivery of a single question to be used in different ways across multiple game formats to multiple players in a synchronised and secure environment.

The invention can therefore allow potentially limitless scalability for future development of new game formats based on a common system comprising a question content pool, a financial system to enable staking and the distribution of winnings, a method of play system and a calendaring system.

In a further embodiment the present invention provides within a unitary system the opportunity for a participant to select a game from different game types and formats, in which knowledge may be tested and to play the game in the selected type and format.

In a further embodiment the unitary system enables the participant to place a stake on the correctness of the outcome of the testing of the knowledge, which may or may not be performed in a competitive environment with other participants.

On line systems for playing games and for testing knowledge are known, as is the ability to place a stake on the correctness of the knowledge. Systems are also known in which this can be performed in competition with others. For example the popular television program “Who Wants to be a Millionaire” can now be played on line over the internet in a single player format.

These systems however suffer from the disadvantage that the number of participants is limited, the forum of play is mono-dimensional and the participants choice in the nature of the “game” or knowledge test environment is extremely limited. Any staking options are also limited and are not structured to reflect the participants confidence in their answer and their ability to exercise their skill and judgement.

The present invention therefore provides an integrated on line entertainment system which enables the participant (the player) to select an entertainment selected by the player from a significantly increased number of entertainment options. The invention can couple this entertainment system with a staking system and various methods of play to provide greater on line flexibility to the participant according to both the form and nature of the game. One result is that the system is, to a greater extent than with previous systems, driven by the participant (the player) rather than by the system provider. Additionally the system provides the opportunity for participants to utilise the invention to create their own on line entertainment experience.

The present invention therefore provides an on line entertainment system involving one or more servers and a plurality of players' client stations for the provision of games whereby the interaction between the player and the game server results in the production of various screen shots on the players display which provide the ability for the player to decide whether to participate in a game and enables players to select both the nature of the game and method of game play.

In a preferred form of the present invention a game comprises one or more multiple choice questions in which the player will be provided with several, usually four, possible answers to a question and is provided with the opportunity to attempt to select the correct answer. The interaction between the player and the game server will allow the player to select on line the game method of play, for example he or she may choose a tournament or an individual game, the interaction will also allow the player to select the nature of the question from a series of categories and/or subjects provided. Examples of such categories can include sport, movies, television, general knowledge etc and examples of subjects within categories are tennis, baseball etc. Having selected a category and/or subject for the game one or more questions will be displayed according to the format of game selected and the question will then be provided on the player's screen ready to be answered within a prescribed time.

In a further embodiment the entertainment system of the present invention allows the participant to place a stake on the correctness of their answers to the questions by selecting from staking options provided as screen shots on the players display. The system provides an additional degree of flexibility to enable the participant to select a particular size and type of stake according to the game format selected and the method of play.

Another novel and important feature of the present invention is that the entertainment can operate in different formats simultaneously and furthermore the various formats can be available to participants around the world simultaneously. By “Game Format” we mean the overall nature of the way in which questions are delivered and/or displayed to the players. The game format can be individual testing or can be a tournament in competition with others. Whilst there are many format options examples of four preferred entertainment formats and how they may be played are as follows.

### (i) TOURNAMENTS

A tournament is a multiplayer game where each player starts by making a specific fixed commitment to ‘join’ the game. This may be an initial financial outlay as approved and audited by the financial system. Game play may vary by parameters such as whether players are allowed to pass on a question or are obliged to play and so on, but all players will start with the same fixed amount commitment which can conveniently be represented within the game system by tokens. Winners are identified according to player performance throughout the tournament and prizes/winnings are distributed at the end of the tournament.

Tournaments operate at specific times in the calendar as indicated to a potential participant by the calendar system and can be provided on demand. Some tournaments will require preregistration by the participant before the tournament commences.

### (ii) Pyramids

In a pyramid game players can progress from one (lower) level of the game to a higher level, alternatively players may enter a pyramid game at a level selected by the player. A player may also leave one pyramid game with credits to play at a particular level and may use these credits to enter another pyramid game. The staking system can be controlled according to the level of the pyramid and also according to the manner in which the player wishes to enter the pyramid.

Pyramids may operate either at specific times in the calendar as indicated to potential participants by the calendar system or they can be provided on demand. If a pyramid is only running at a specific time, as indicated by the calendaring system, it will require preregistration by the participant before the game commences.

(iii) Open Games

An open game is another multiplayer game where each player ‘buys’ a certain number of tokens to play for as long as they like or until the players tokens are spent. Each question is run individually and players can decide whether to place stakes to play the question or to pass. Players who guess the correct answer to the question receive an equal share of the tokens in the total kitty generated for that question and these are added to their own game token balance.

Players may join an open game after it has commenced and may leave at any time before the game has finished. When a player leaves an open game their token balance within the game is converted back into ‘cash’ which is credited to their wallet via the financial system.

Open games operate at specific times in the calendar as indicated to the potential participant by the calendar system. An open game does not require preregistration before the game commences as players may come and go as they please.

### (iv) Teasers

A teaser is a single player game which allows a player to play ‘for free’ with no prizes, teasers can operate continuously on a start-on-demand basis.

Within each format it will be necessary for the player to answer a question within a prescribed time and the system also indicates on the player's screen the time remaining to provide the answer to the question.

A facet of the system is that the question provision can be synchronised so that one question can be provided to the players on their screen simultaneously in all forms of entertainment. This requires the provision of a question delivery system which is programmed to stage and synchronise the steps required for the selection of a question across the different game formats. This therefore needs to allow for the time allotted for one or more periods for the selection of a category or subject (for example the category may be “sport” and the subject “tennis”), the time allowed for the decision whether or not to play the question (if included) and the time allotted for answering the question, the amount and type of the stake and the time allotted to answer the question before the answer is provided by the system. This staging and synchronisation may be accomplished by the techniques described in our co-filed patent application reference number PACLBA605.

The system therefore allows one or more on line participants to answer the same question in different game formats and perhaps with a different method of play and amount of stake simultaneously. The tournament game play can also allow the participants to choose various stake options and allows the different options to be employed by different participants on the same questions at the same time.

The game format also includes the scope of questions that are provided within any particular open game or tournament. For example, the participant may be provided with the following three options on the scope of question:
a. A classic game in which the question can be drawn at random from the entire question database irrespective of the category of the question or the subject of the question.
b. A masters game in which the question is drawn at random from all subjects within a selected category (for example sport)
c. A specialist game in which the question is drawn from all the questions within a particular subject (for example tennis)

The number of questions in a tournament can also be varied for example tournaments can contain: 20 Question, 40 Question or 60 Question tournaments.

The time available to answer questions can be varied, for example there may be 36 Second Questions, 48 Second Questions or 60 Second Questions

The question provision system is synchronised so as to provide the same question simultaneously to each player wishing to play the question irrespective of which combination of these variables is selected by each player.

By “Method of play” we mean the manner in which the game is played including the manner in which stakes can be placed on the correctness of the answer and also the amount that can be staked.

Method of play is described in our co-filed patent application reference PACLBA530.

The system of the present invention allows the following tournament methods of play for classic, masters or specialist tournament/games:

The choice of 2 types of staking can be provided to the player: Real Money or Play Money and these can generate three types of rewards, real money, play money and prizes.

The amount staked can be varied, for example: there may be an entry fee such as—$1, $5, $10, $20, $50 & $100 and players entering a game can receive playing tokens irrespective of entry fee provided to the player by the associated financial system, typically 1000 tokens may be provided per game.

The number of players can be varied within each game type, for example, 21-1,000 Players, 20 Player, 10 Player & 8 Player (Pyramid) can be playing any one game.

The type of game play staking can be varied for example the player may be provided on line with the following options:
Fixed Stakes, Fixed Stakes Must Play, Fixed Stakes Must Play Turbo, Fixed Stakes Turbo
Choice Stakes, Choice Stakes Must Play, Choice Stakes Must Play Turbo, Choice Stakes Turbo
All In Stakes, All In Stakes Must Play, All In Stakes Must Play Turbo, All In Stakes Turbo

### Fixed Stakes:

Fixed Stakes: One level of stake in each round (round=20 Questions)
for example.
   round 1=20 Questions=level of stake say 100 (varies)
   round 2=20 Questions=level of stake say 200 (varies)
   round 3=20 Questions=level of stake say 300 (varies)
10 20, 40 or 60 Question Tournaments
Correct answer pays double the level of stake
Play or Pass Question

Fixed Stakes Must Play: Same as Fixed Stakes, except that the player has to play the Question (whether the player knows the answer or not—If the player does not know the answer the level of stake will be deducted automatically)

Fixed Stakes Must Play Turbo: Same as Fixed Stakes Must Play, except that the player's rewards are based according to the time the player needs to answer the question i.e. for example, if the player answers the question correctly within the first third of the time allowed to answer the question, the stake played could be multiplied by 3. If the player answers the question within the second third of the time allowed to answer the question, the stake played could be multiplied by 2.5, and if the player answers the question correctly within the final third of the time allowed to answer the question, the stake played could be multiplied by 2.

Fixed Stakes Turbo: Same as Fixed Stakes Must Play Turbo, except that the player does not have to play the question.

### Choice Stakes:

Choice Stakes: Three level of stakes in each round (round=20 Questions)
for example
   round 1=20 Questions=level of stake say 100-150-200 (varies)
   round 2=20 Questions=level of stake say 200-250-300 (varies)
   round 3=20 Questions=level of stake say 300-350-400 (varies)
   20, 40 or 60 Question Tournaments
   Correct answer pays double the level of stake
   Play or Pass Question

Choice Stakes Must Play: Same as Choice Stakes, except that the player has to play the Question (whether the player knows the answer or not—Obviously if the player does not know the answer the lowest level of stake should be played—If the player does not play the question in the time allowed, the lowest level of stake will to deducted automatically)

Choice Stakes Must Play Turbo: Same as Choice Stakes Must Play, except that the player's winnings are based according to the time the player needs to answer the question i.e. If the player answers the question correctly within the first third of the time allowed to answer the question, the stake played could be multiplied by 3. If the player answers the question within the second third of the time allowed to answer the question, the stake played could be multiplied by 2.5, and if the player answers the question correctly within the final third of the time allowed to answer the question, the stake played could be multiplied by 2.

Choice Stakes Turbo: Same as Choice Stakes Must Play Turbo, except that the player on their screen does not have to play the question.

### All In Stakes:

All In Stakes: In this instance no level of stake needs to be displayed to the player if the player elects to play the question and to stake “all in” all the player's tokens go into the kitty. This remains the case throughout the entire tournament (i.e. each round)

All In Stakes Must Play: Same as All In Stakes, except that the player has to play the Question (whether the player knows the answer or not—in this method of play if the player does not know the answer the player is eliminated)

All In Stakes Must Play Turbo: Same as All In Stakes Must Play, except that the player's winnings are based according to the time the player needs to answer the question i.e. for example, if the player answers the question correctly within the first third of the time allowed to answer the question, the stake played could be multiplied by 3. If the player answers the question within the second third of the time allowed to answer the question, the stake played could be multiplied by 2.5, and if the player answers the question correctly within the final third of the time allowed to answer the question, the stake played could be multiplied by 2.

All In Stakes Turbo: Same as All In Stakes Must Play Turbo, except that the player does not have to play the question.

The system further provides various methods to play Open Games including:

### Classic:

Real Money or Flay Money
21-1,000 Players
Random selection of questions across all subjects and throughout all categories of questions
60 Seconds per question
Entry Fees—$0.5-$1-$1.5, for example Staking 6 Variables
$1-$2-$3
$2-$4-$6
$3-$6-$9
$4-$8-$12
$5-$10-$15
Game Play e.g. $1-$2-$3

By way of an example a game play may proceed as follows:

Entry Stake prior to showing category=50% initial stake—i.e. $1-$2-$3=$0.50
Category Revealed—Play or Pass—If played stake=$1
Subject Revealed—Play or Pas—If played stake=$2
Question Revealed—Play or Pass—If played stake=$3

### Answers Revealed

All the players stakes at all stages of the open game go into a kitty. The kitty may be divided equally to the remaining players who have answered the question correctly

### Masters:

Same as classic except it involves the random selection of questions on all subjects throughout one category only and no question category is revealed to the player as it has been preselected. Only the subject and the question itself are revealed for player choice

Only 2 stakes required for example $1 to play the revealed subject and $2 to play the question

### Specialist:

Same as classic except that the questions are within one subject only and no category or subject is revealed as they have been preselected

Only 1 stake required i.e. $1 to play revealed question

The game play system, the financial system and the client interface are integrated so that the staking options are displayed to the player on their client screen, tokens are provided to the player for staking, the tokens are provided at the appropriate time according to the game format chosen, the rewards and losses are calculated, a financial credit or debit is made to the player's account and a report is provided to the player. The report may also include a relative ranking of performance of players within a tournament.

In the preferred system of the present invention the question provision/game play system previously described is combined with a financial system that supports participant staking. In order for effective operation it is preferred that the financial system provides the following features:
a wallet (or account) for each participant
payment provider integration
security
assists in responsible playing
financial incentives
audit and reporting

The wallet is a virtual wallet system which stores currency usually as dollars and has the following functionality:
the ability to deposit currency into the wallet from customers' credit and debit cards via a payment provider.
the ability to withdraw currency from the wallet into the customers' credit and debit cards via a payment provider.
as an option the ability to pay large winnings out via cheque and account for these in the financial system; this facility may be required when any payment is required that is above the amount that the payment provider will allow to be credited to the credit or debit card.
the ability to view a statement of all transactions made against the customers' wallet.
the ability to adjust the monthly deposit amount for each customer to enable responsible playing the ability to store multiple credit card balances (between 1 and 5 cards).
optionally the ability to transfer money to another user; this would include the ability for the user to enter their password
In the preferred operation the wallet holder is informed preferably by email, on the following events:
   when prize money is deposited into their account.
   when a deposit is made into their account.
   when a withdrawal is made from their account.
   when money is transferred to or from other parties.

It is also preferred that regular statements are provided to each player to show statements of total winnings or losses, these may be provided on a daily, or weekly basis.

It is also preferred that the financial system fulfill the following Security Requirements any personal data that is revealed is transmitted over secure socket layer (SSL).
any payment workflow functions is protected via SSL.
any card administrations functions must be protected via SSL.
data integrity is provided throughout the financial system.
transaction log backups are required very frequently so that if the database has to be recovered then the transaction loss impact is minimal.

The financial system can also be the vehicle to ensure, responsible playing, the provision of incentive systems and appropriate audit requirements.

Responsible Playing, is an option provided to the user to limit the amount of money that is to be placed in account deposits within a defined time-frame such as one month. If the user does not opt-in, the deposit is unlimited. If the user wishes to adopt the responsible play feature, there is a second step at registration, which is an opt-in procedure which defines the maximum deposit amount that the account holder can make in the defined period, which is generally a month which could conveniently run from the first of each month to the last day of the month. The maximum amount can be overridden only through an administration interface if a request to raise the limit is submitted. There would not be an option to increase the limit although the limit could be removed with approval by the administrator. No authority would need to be provided in order to decrease the limit.

The system may also provide an incentives system which will allow a user to deposit either a fixed amount or a percentage on top of the amount from their card on entry of a bonus code. In the preferred operation the bonus code can only be used once per user. A user cannot withdraw the bonus amount from their account unless it has been converted to winnings via a game; the bonuses should have automatic start and end dates and it is also preferred that the bonuses should be administrable from the system administration site.

The financial system should also provide the facility for effective auditing of the entire activities and the requirements for accounting regulations are that the system should hold a list of accounts and these may conveniently broken down as follows:
Customer accounts. Synonymous to the wallet. This will store the transactions between customers and the games; preferably there will be one customer account per customer per site.
Play account. This will store the currency that is currently in play in any one game.
Check out account. This will store cheques which have been paid out and will maintain a permanent zero or negative balance; conveniently each client will have a single account.
Payment provider accounts. This will store all transactions made from and to the payment providers; again there will be one account per provider. Only approved transactions will be logged.
Freeroll accounts. There needs to be a freeroll account for each freeroll game type (tournament and open to start with) which contains the amount of currency available in the freeroll jackpot.

It is preferred that all transactions be made against these accounts. A transaction record will hold the source account, the destination account, the IP address of the transaction initiator, the value of the transaction and the date and time the transaction is made. In the case of a play-account transaction, the reference to the game to which the transaction is related will also be stored against the transaction.

A payment workflow is provided to deposit money into the account based on 1-5 pre-stored cards other payment and withdrawal methods. To make a deposit, the card's CVV or VBV pin number and the amount should be entered as well as the user's password to confirm when making a deposit to confirm the card holder is present. All transactions are preferably in the same currency, preferably in United States dollars preferably the payment workflow should be protected with SSL.

One difficulty with previous on line entertainment systems is that it is necessary to have a sufficient number of participants on line at the same time in order for the game to proceed. Accordingly a new participant will often be told when logging on to play the game that there are insufficient participants for the game to proceed. Accordingly, in a further embodiment of the present invention phantom participants (known as ghosts) are provided whereby; there can be sufficient participants (real and ghosts) to enable a game to proceed. Where the system is used for staking upon the answers to questions the system further provides as a component of the financial system a separate staking system for the ghost players whereby the ghosts can place selected stakes and will lose whatever is staked if they are incorrect and any rewards they may make are recycled to the ghost financial pot to enable further ghost staking. In this way the ghost activity can be designed to be financially neutral. A system for the provision of ghosts and their staking is described in co-filed patent application reference PACLBA529 and in a preferred embodiment this system is integrated with and synchronised with the system provided by the present invention.

The ghosts have been created to ensure that each game or tournament not only has a sufficient number of “players” but also that the ghosts have “real player experience” irrespective of whether a player is real or a ghost. Ghosts will be activated to play against real players and each ghost will be provided with an AI (Artificial Intelligence) device, any number of ghosts may be provided and unique parameters are provided which influence the way in which ghosts play are developed so that each ghost has its own unique playing characteristics.

For example the following characteristics can be provided to and varied within each of the ghosts:
(i) intelligence factor—which can be randomly attributed to each ghost on a scale
(ii) pass factor—which determines the likelihood of the ghost to pass a question
(iii) risk factor—which determines the propensity of the ghost to gravitate towards high stakes
(iv) speed factor—which determines the speed at which the ghost will respond (which can have significance in turbo games)
(v) favourite category—each ghost can be provided with a favourite category or subject so that they are likely to participate in that category but not definitively on every occasion they play

These unique parameters will determine whether the ghosts plays of passes, whether the ghost gets the question right or wrong, and the speed at which the ghost plays.

Ghosts are non-profit making and are funded from allocated “ghost balances”. The ghosts may be integrated with the financial system to provide separate ghost balances for each category and subject. Ghost balances usually contain real money that has been allocated to them and when the ghost loses the ghost stake is contributed to the pot for the winners. Any ghost rewards are recycled into the ghost balances.

The ghosts may be given gender, screen names, nationality, age and taglines in order to make them “real” players for the purpose of interacting with other players to whom the ghosts are real people.

The system is such that all elements of “ghost play” are random apart from the selection process at the outset of the game and tournament. If the “ghost balance” for the subject/category is low then intelligent ghosts may be selected who are more likely to win, if the ghost balance for the subject/category is high, then ghosts may be selected from lower down the scale of intelligence.

The present invention therefore provides an entertainment system which provides to an on line player through the interface between the player and the underlying software of a game server, a highly versatile and flexible on line entertainment system with or without staking. The system may also be used as an educational system in schools, colleges and other educational and certification outlets. The system also has the flexibility to provide for private tournaments which can, if desired, be based on question provided by those who are organising the tournament. For example this facility would enable communities and groups scattered around the world to participate in a single, unitary tournament via the internet.

The invention also provides the ability to synchronise the question selection on a random basis to allow the same question to be used simultaneously in a variety of tournaments. This synchronised question selection can be coupled with the ability to apply different staking techniques and methods of play simultaneously to the single question by as many participants who wish to participate.

A significant benefit is that the synchronisation reduces the number of questions that are required to provide such a versatile and flexible real time entertainment experience. The system provides also:
tournament calendar/timing and position reporting to participants
multiple simultaneous multi player game play for open games and tournaments
theoretically can be played by an infinite number of players
variety of navigation options to display the game calendar, including providing the ability for individual users to customise their own calendar
correlation and synchronisation between open games (cash games) and tournament play (entry fee)
use of ghosts to ensure that users can always have “real experience” even when limited number/no other players
a wide variety of methods of play and staking
financial accounting, auditing and reporting

Accordingly it can be seen that the present invention provides a wider range of entertainment and staking opportunities and combinations than has previously been provided and provides increased choice and flexibility to the participant therefore providing a greater scope of entertainment options.

The present invention and its operation are illustrated by reference to the accompanying drawings in which

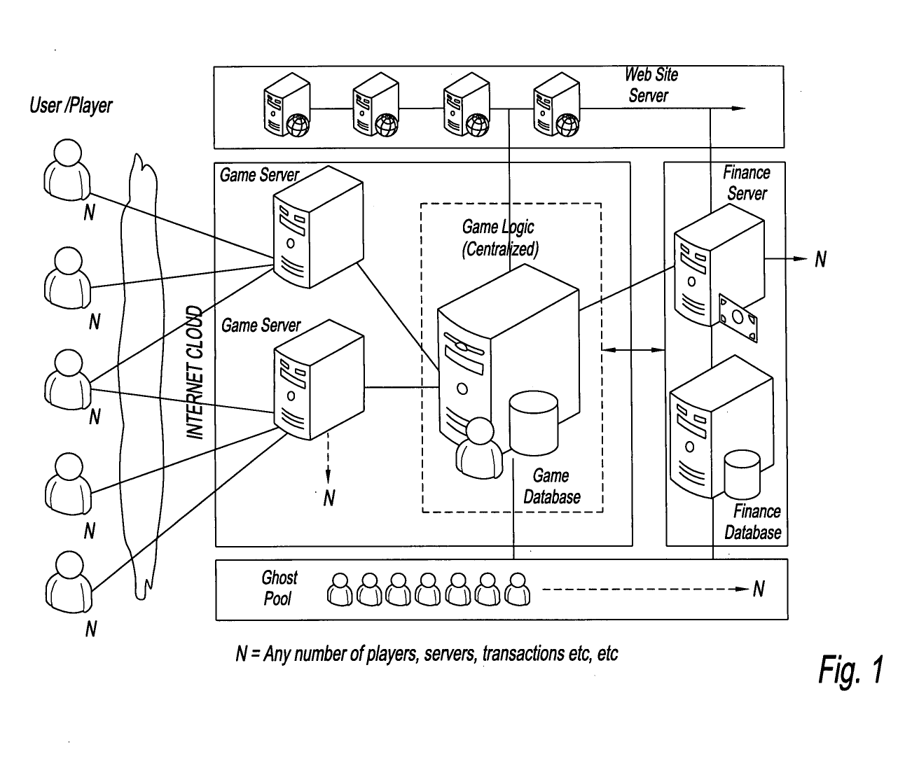

FIG. 1 shows a network system useful for operation of the present invention to enable the provision of multi-faceted entertainment. FIG. 1 shows how a centralised system containing the game logic is linked to game servers which are then linked through the internet to individual client stations for user/players. Also included is the financial system showing its interface with the central game logic and database system.

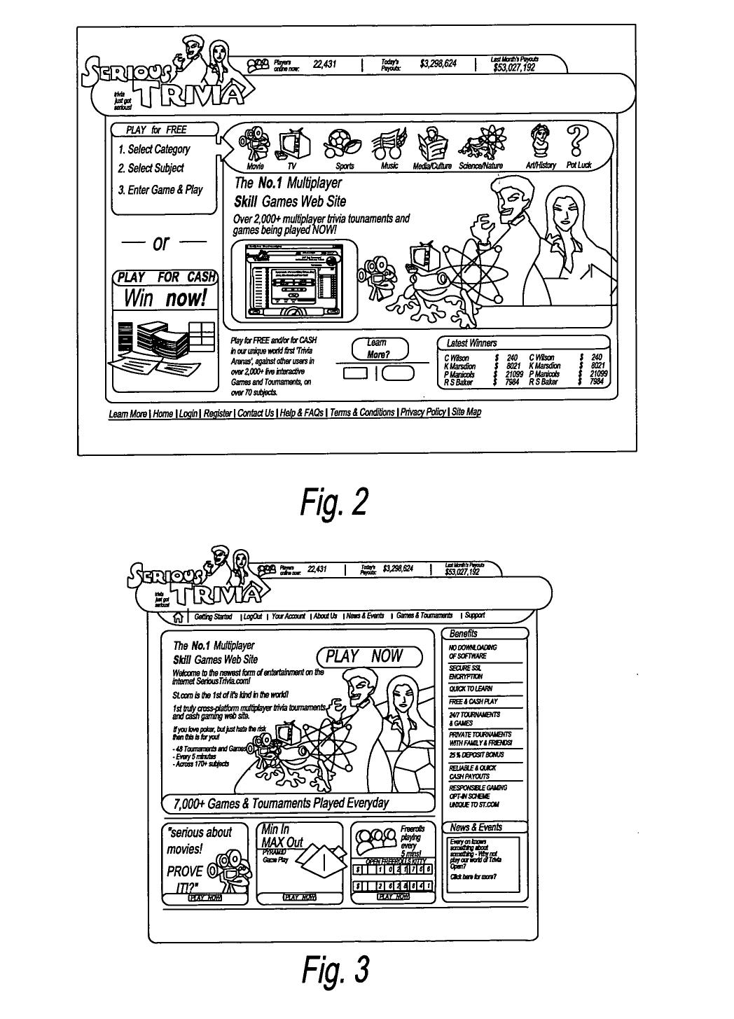

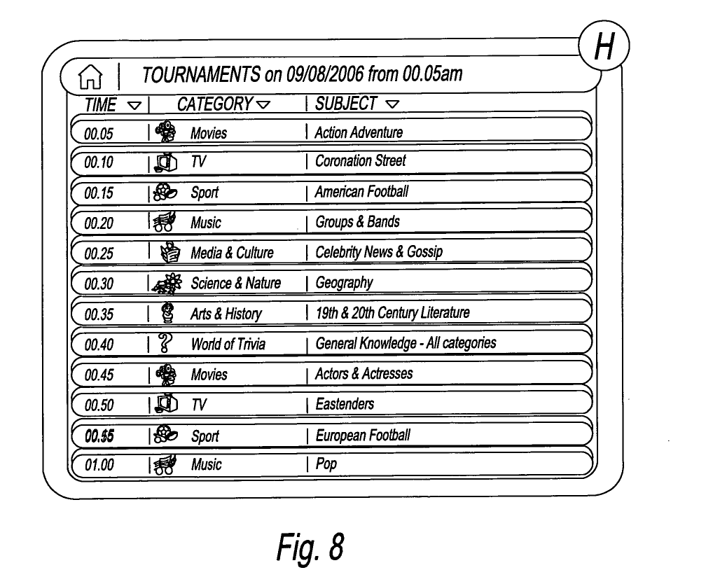

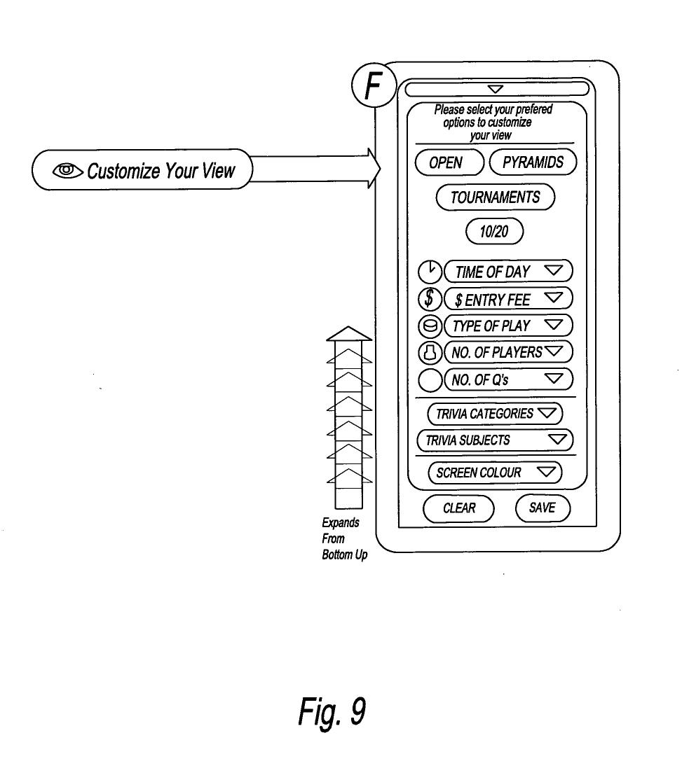

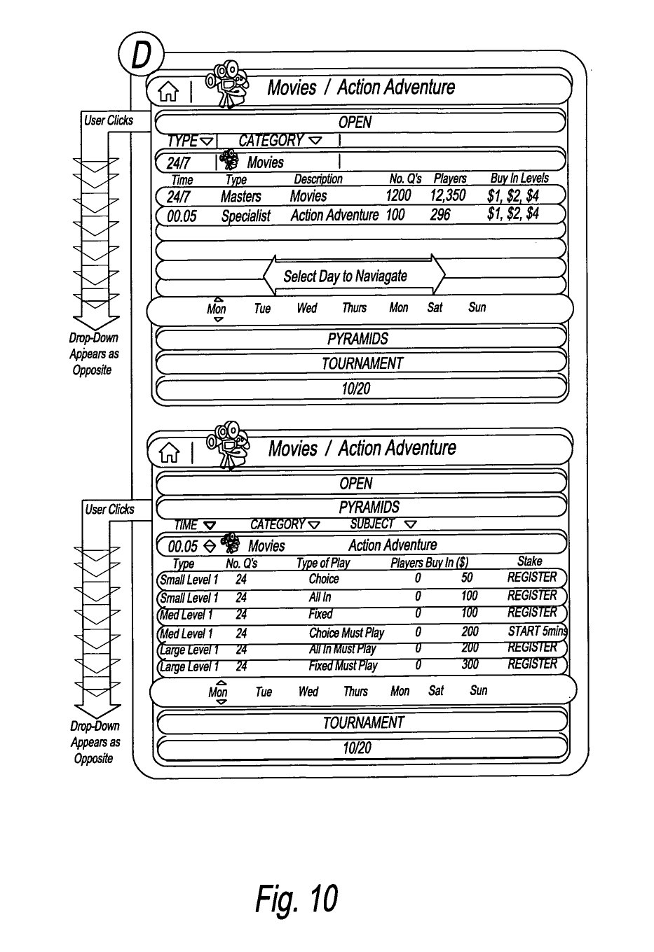

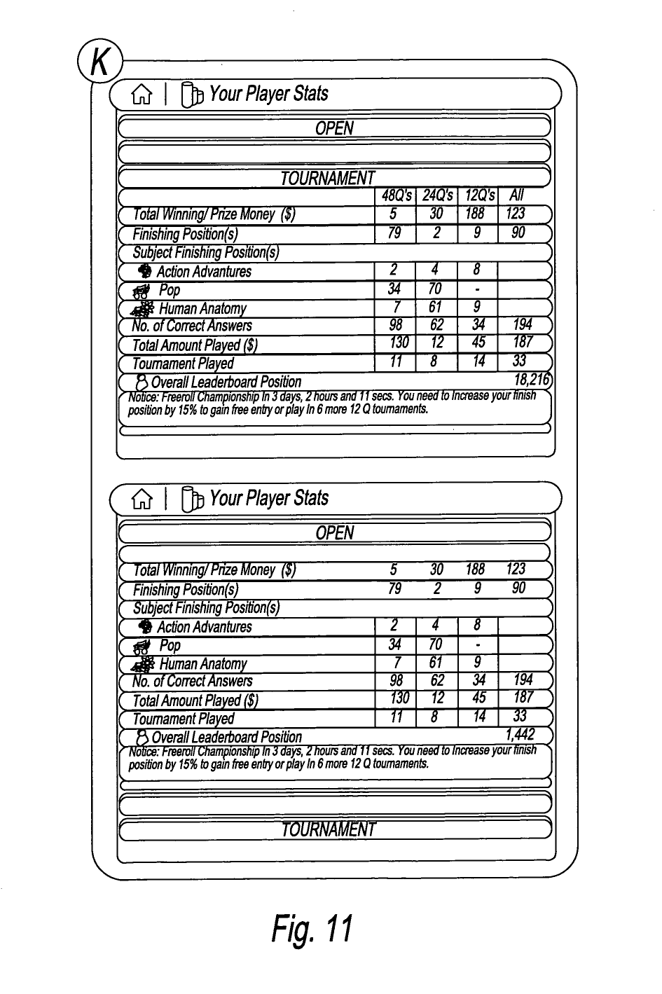

FIGS. 2 to 14 are screen shots provided to the participant on a client facility to enable implementation of the type of entertainment according to the present invention.

FIG. 2 shows a screen shot which may be obtained by a client upon entry into the system of the present invention from a web such as the internet.

FIG. 3 shows the “home page” which may be derived from clicking “Learn More” on the screen shot of FIG. 2.

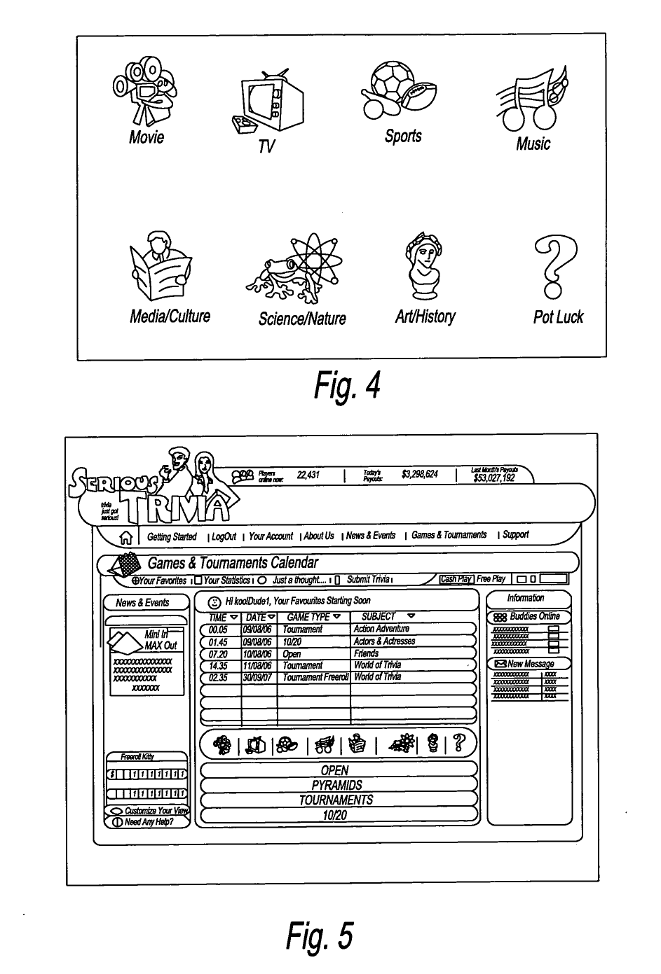

FIG. 4 shows the icons which can be exhibited to show the categories of questions that are available to the participants.

FIG. 5 illustrates a screen which provides the options for the participant to choose the type of game he or she wishes to play, the subject matter available and when the combination of choice will be available. These screens may also be structured to provide additional information such as the number of players currently on line, monies paid out and can also provide a link for the exchange of e-mails with, for example, other participants.

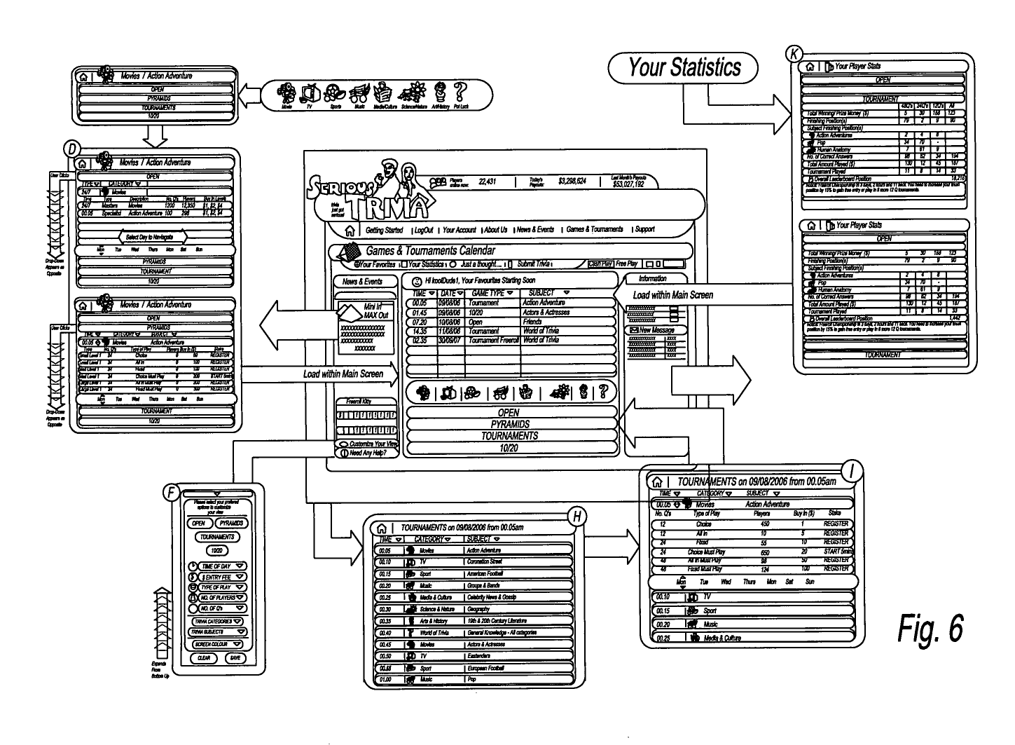

FIG. 6 shows the navigation options provided by the screen of FIG. 5 and illustrates the information detailing the entertainment system of the present invention that can be provided through features B to I of the screen of FIG. 5.

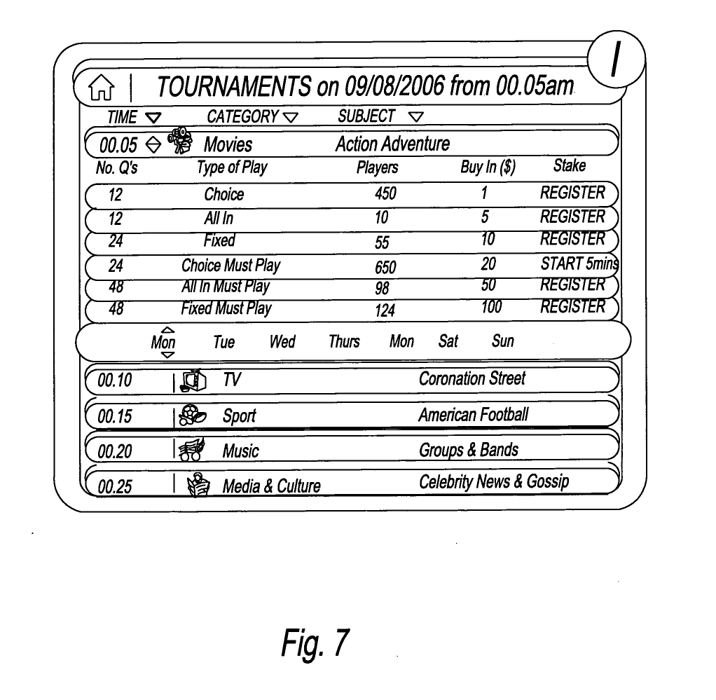

FIGS. 7 to 11 are expanded versions of features I, H, F, D and K of FIG. 6.

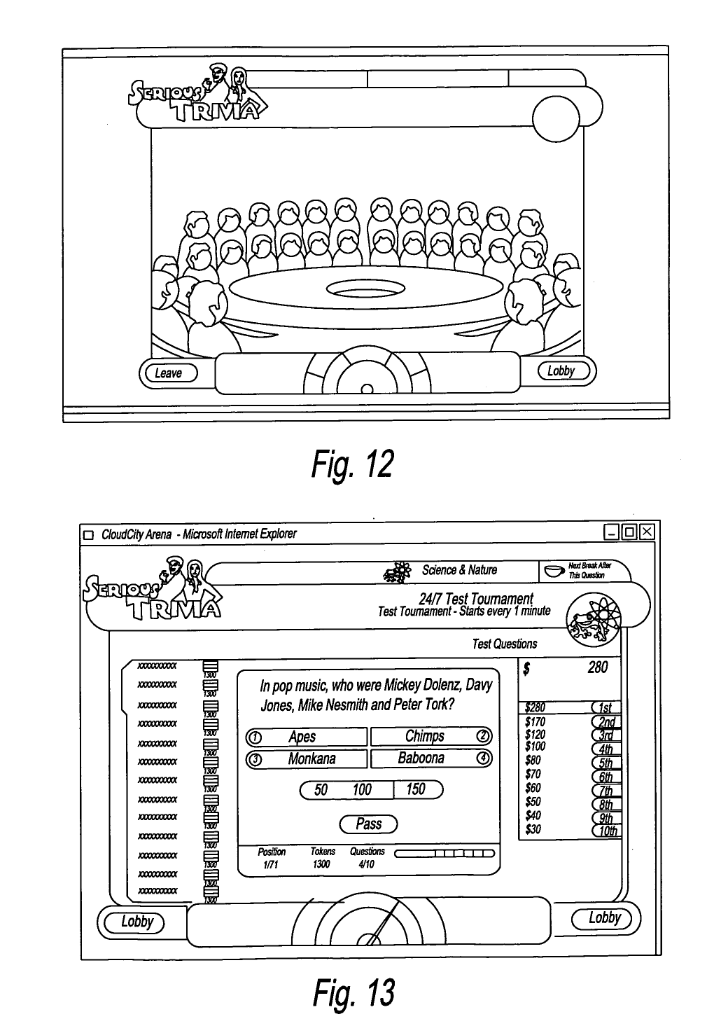

FIG. 12 shows the screen of the area of play that may be obtained once the participant elects to enter the system to enable him or her to obtain a question to enable him or her to decide if he or she wishes to participate and attempt to answer the question.

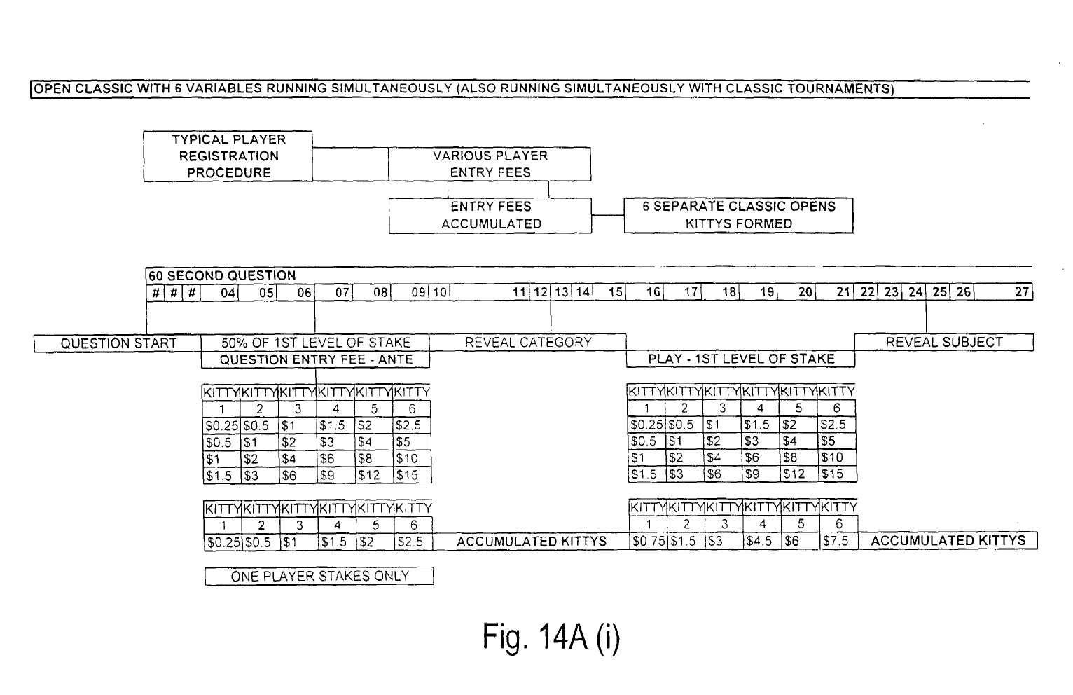

FIG. 13 shows the screen of FIG. 12 to which a question has been added and in which the clock has been activated to indicate the time in which the participant must decide if he or she wishes to participate and attempt to answer the question. If the participant elects to attempt to answer the question the clock will then indicate how long the participant has to answer the question. Depending upon the format selected the clock may also record how long it takes the participant to answer the question and calculate the return on the stake if the format is time dependent. FIG. 13 also shows the staking options provided, provides the names of the players participating in the tournament and the current hierarchy within the tournament and shows also the amount of money (or tokens) in the account of the participant.

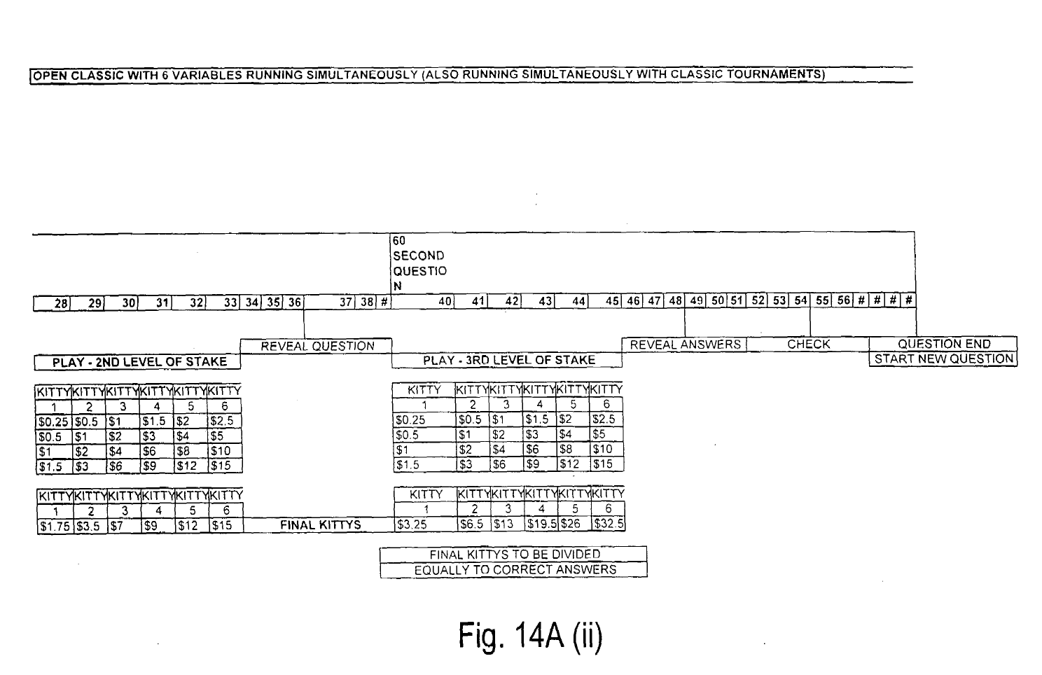

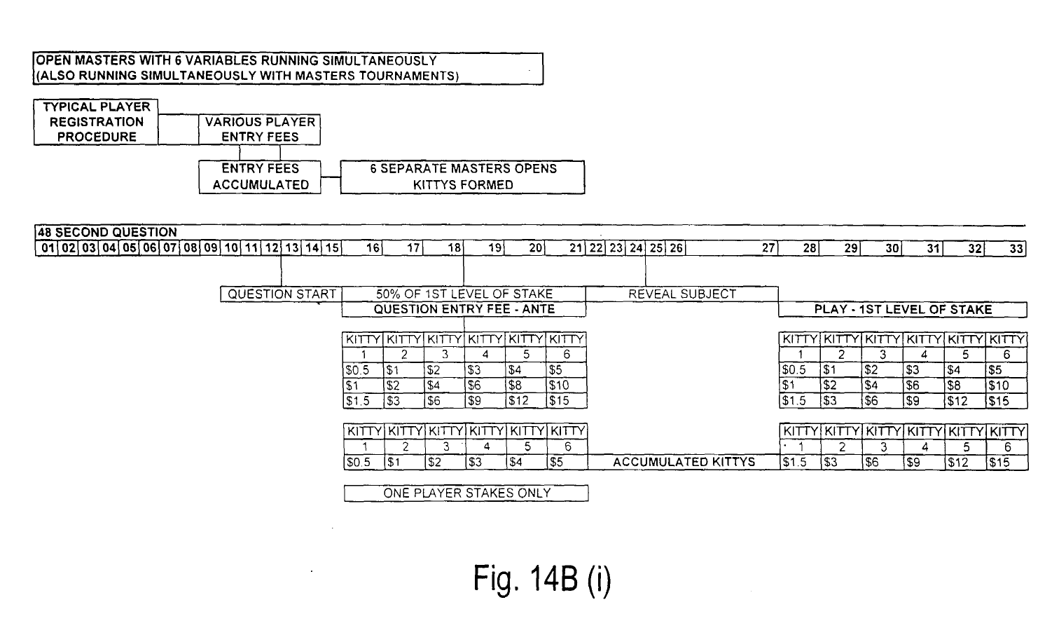

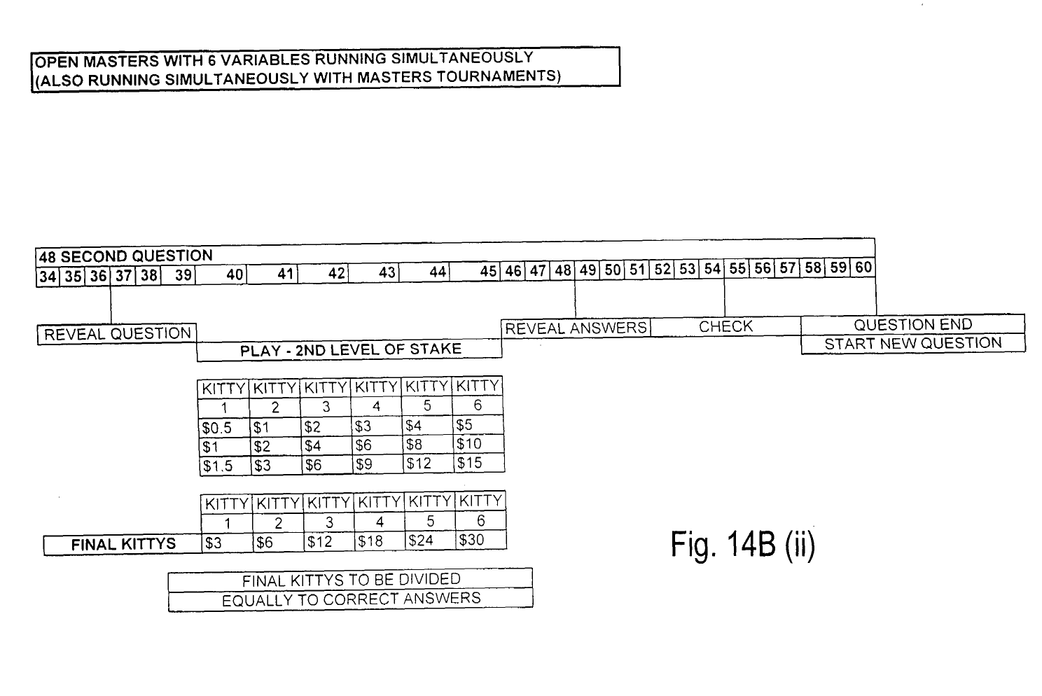

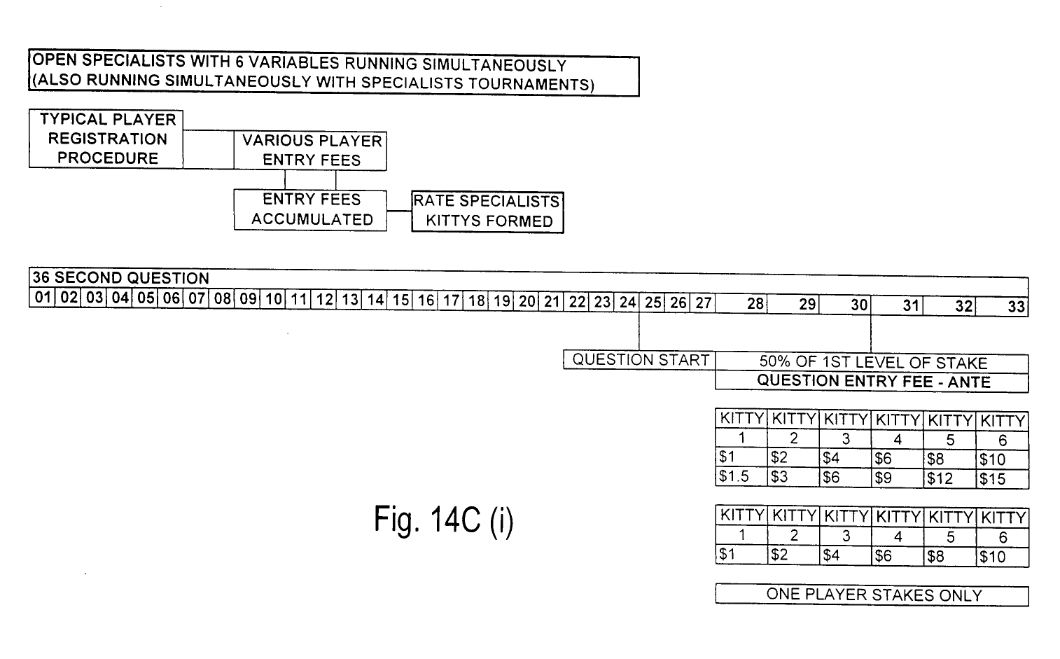

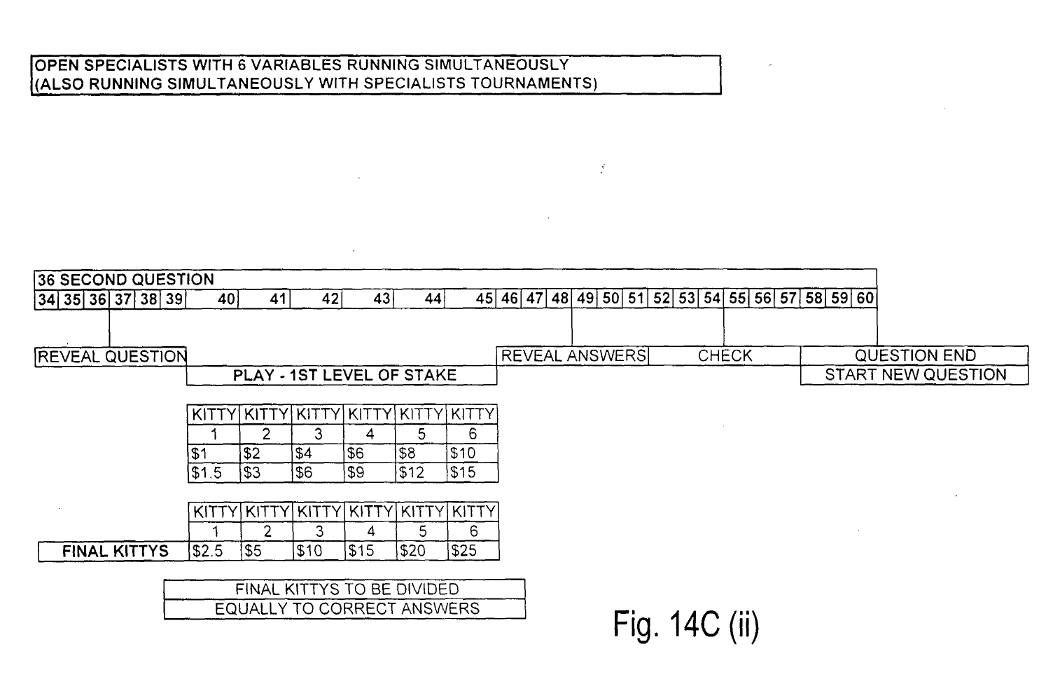

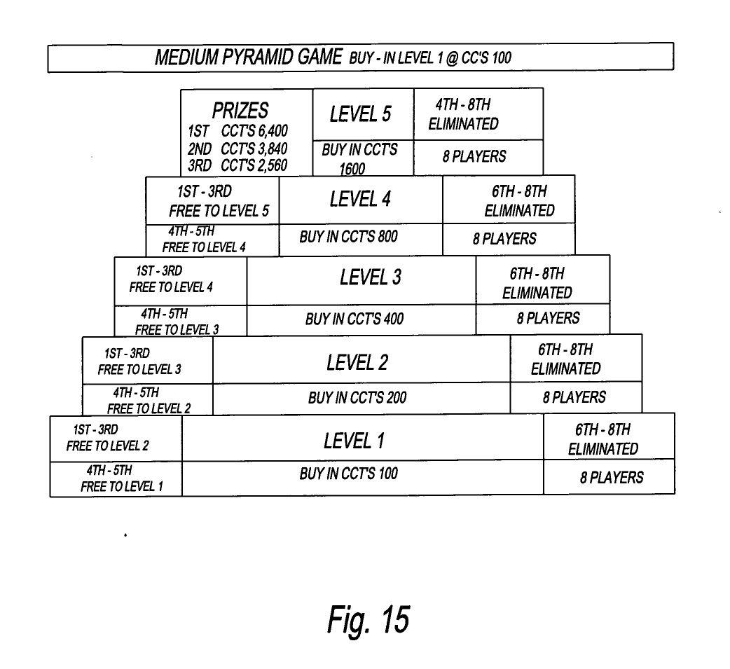

FIG. 14 shows how open classic, open masters and open specialists games each providing 6 staking options can be run simultaneously with the delivery of the same question in each game at the same time. FIG. 14(a) shows the time line for the delivery of a question in an open classic game in which the question is developed and answered in 60 seconds, FIG. 14(b) shows how part of the same time line is employed so that the same question can be delivered in a masters tournament at the same time as it is delivered in the classic tournament. FIG. 14(c) shows how the same question can be delivered simultaneously in a specialist tournament. The figure also shows how the various game formats can be played with different stakes which within the classic and masters tournaments can be varied at different stages in the question delivery process and how the kitty can be accumulated.

FIG. 15 is a schematic illustration of the operation of a pyramid game showing how 8 players can participate in a pyramid of 5 levels wherein players are eliminated and replaced at various levels according to ranking within the players participating in the tournament. As can be seen, the number of players remains constant and eliminated players may be replaced by players who have qualified for a particular level in another pyramid or by players who buy into the level of the tournament at the appropriate level of stake.

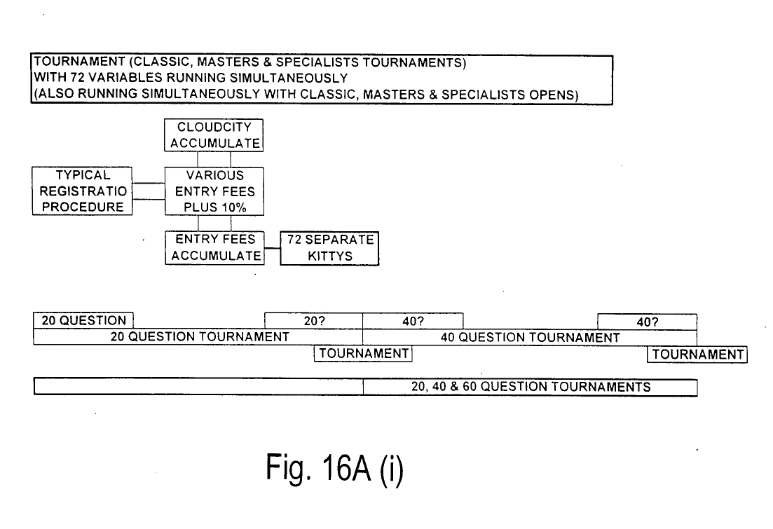

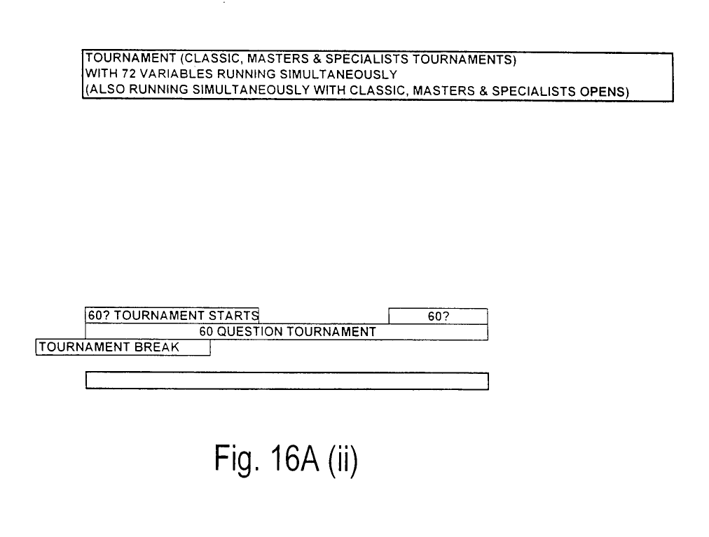

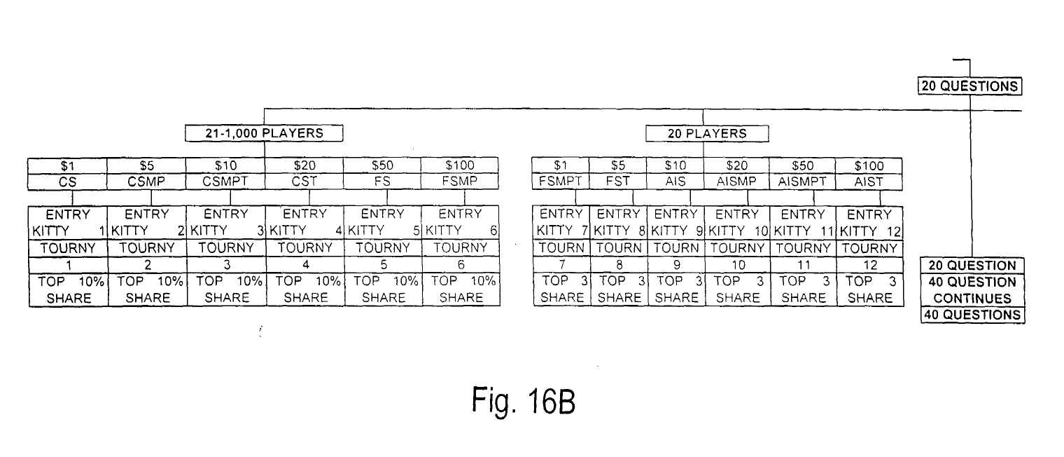

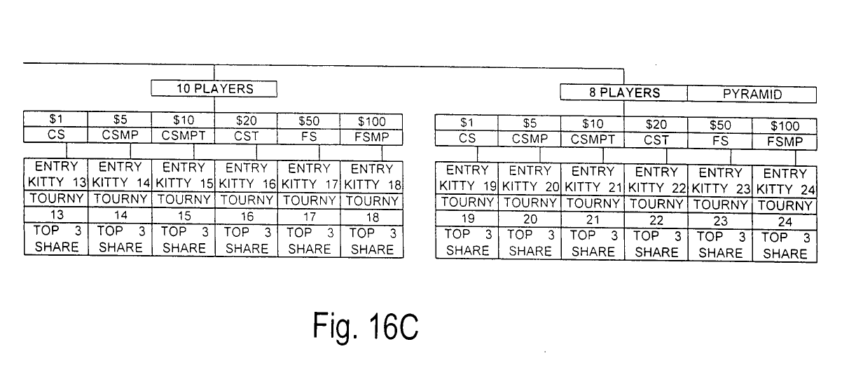

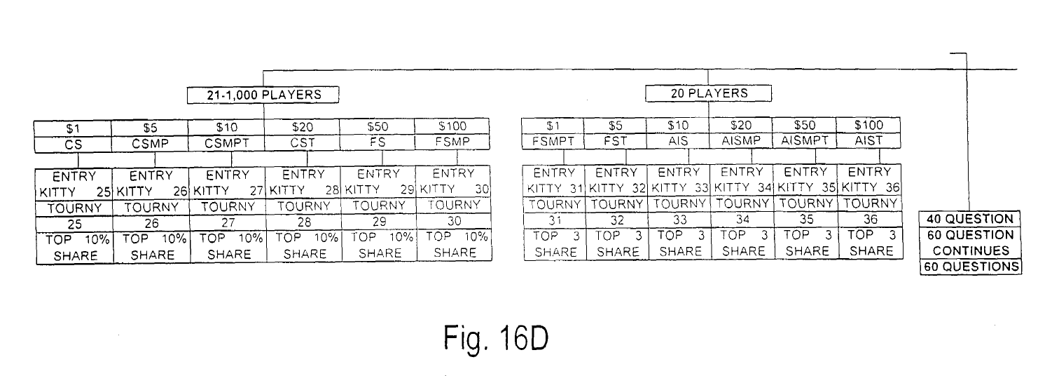

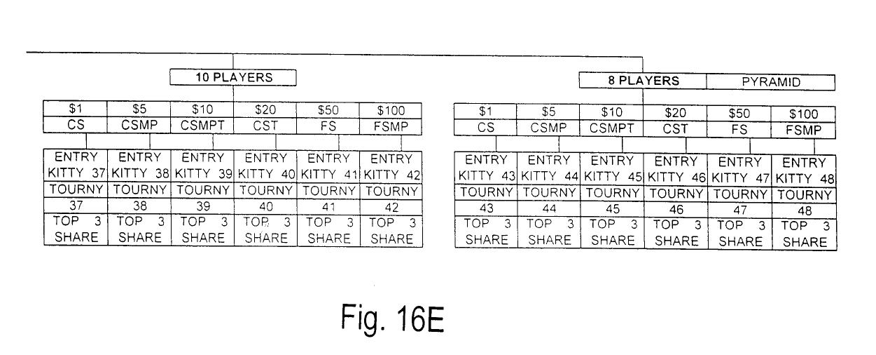

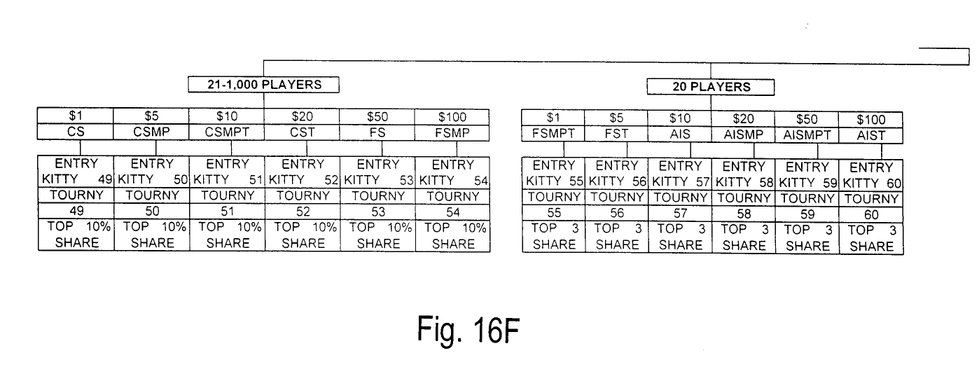

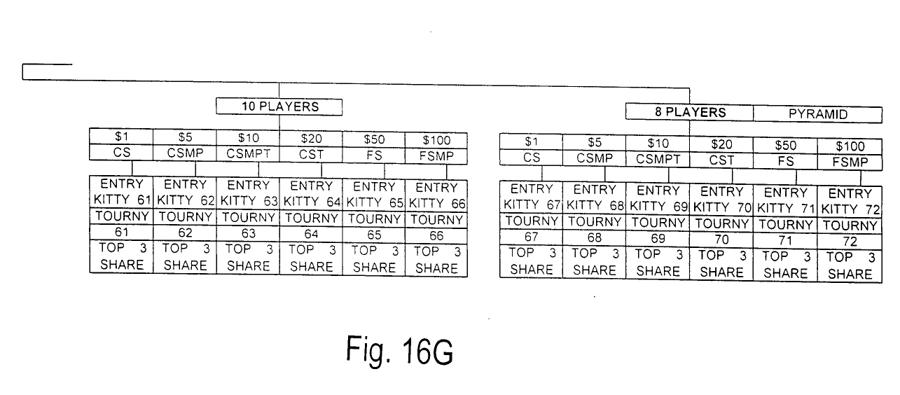

FIG. 16 shows how 72 tournaments can be played simultaneously wherein the number of players is varied, the number of questions in the tournament is varied (20, 40 and 60) the stake can also be varied. The following abbreviations are used for the different methods of game play that are employed in FIG. 16.
CS=Choice Stakes
CSMP=Choice Stakes Must Play
CSMPT=Choice Stakes Must Play Turbo
CST=Choice Stakes Turbo
FS=Fixed Stakes
FSMP=Fixed Stakes Must Play
FSMPT=Fixed Stakes Must Play Turbo
FST=Fixed Stakes Turbo
AIS=All In Stakes
AISMP=All In Stakes Must Play
AISMPT=All In Stakes Must Play Turbo
AIST=All In Stakes Turbo

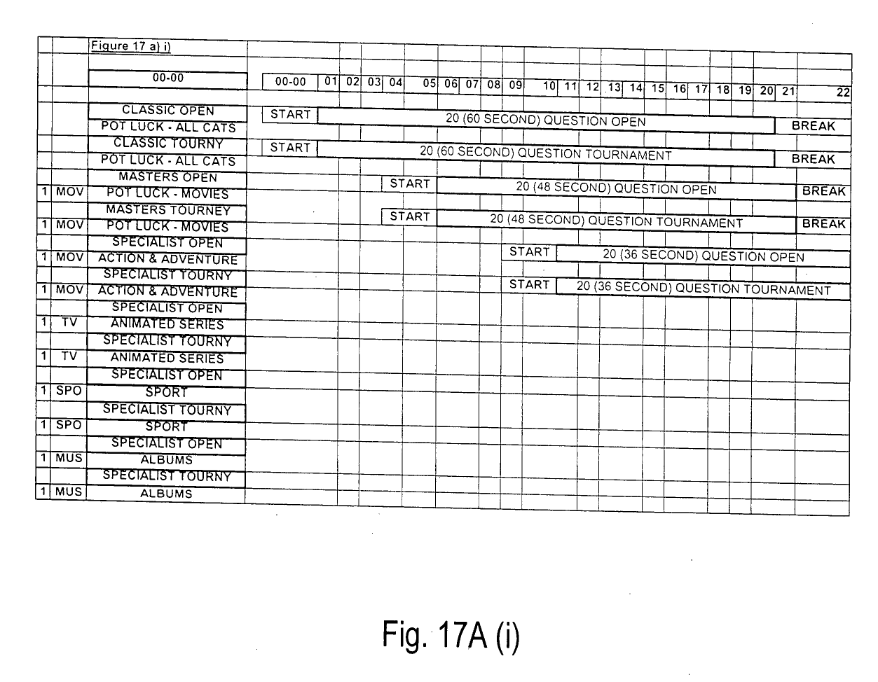

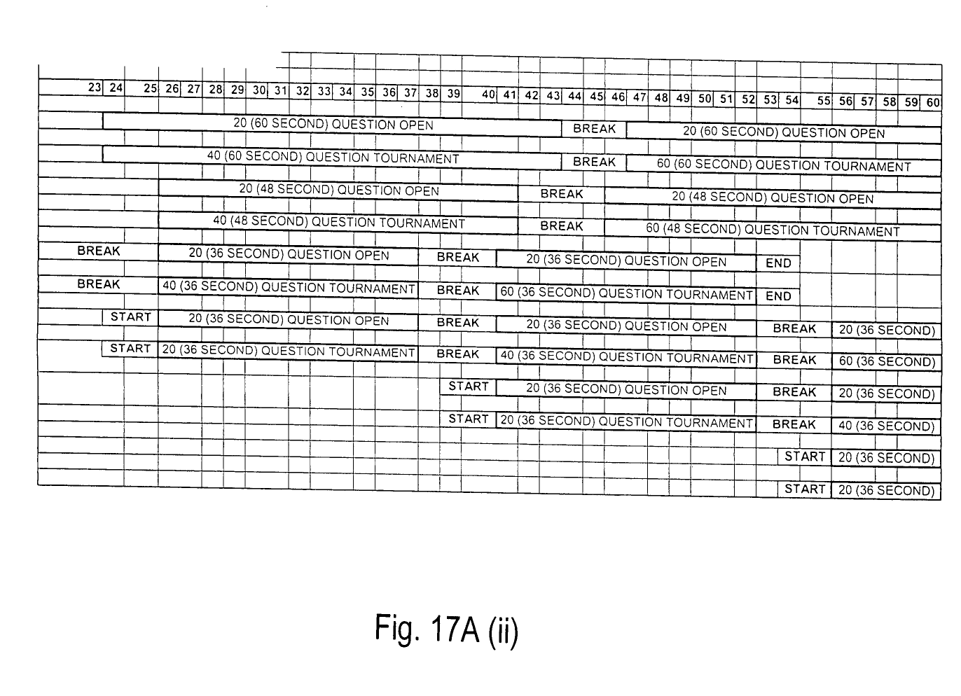

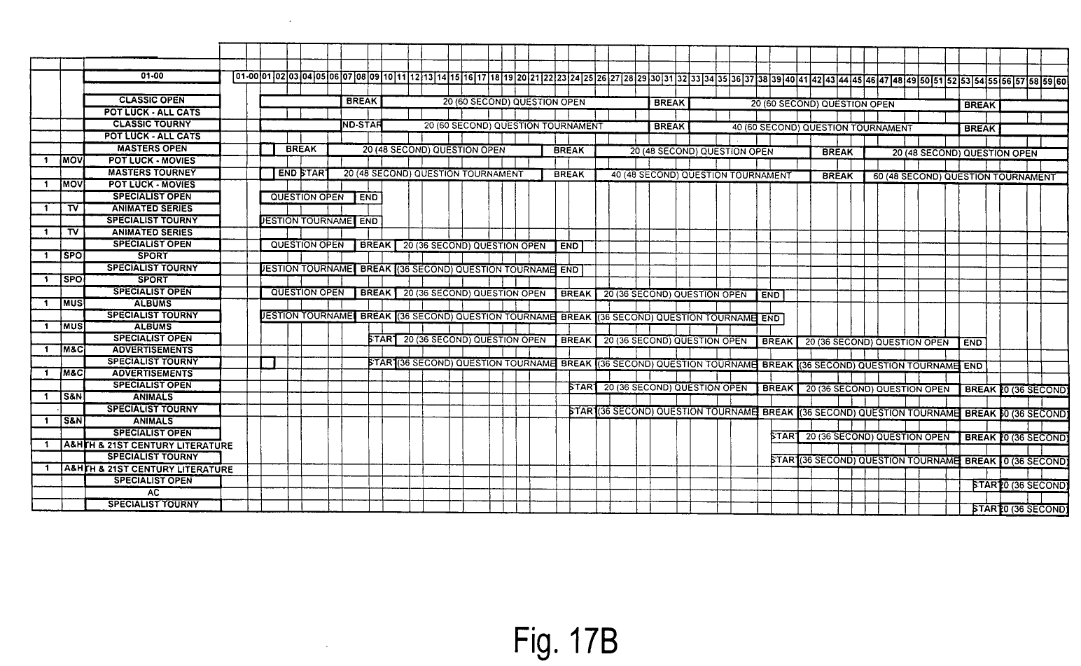

FIG. 17 shows how open game such as those shown in FIG. 14 and the tournaments such as those shown in FIG. 16 can be synchronised so that the same question is delivered simultaneously to all the forms of play.

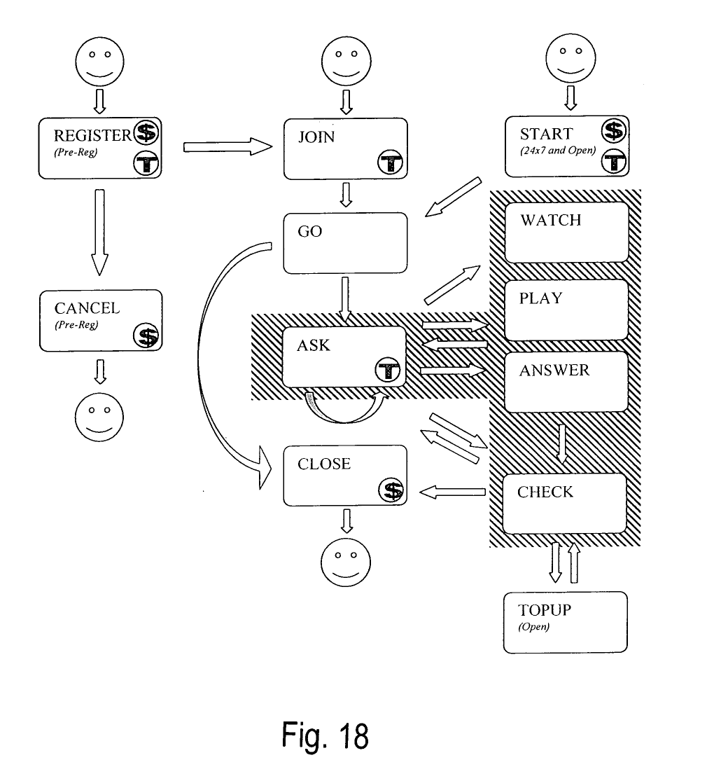

FIG. 18 is a schematic process flow diagram which illustrates the overall process flow for game play and each box represents an instance of communication between a client (as shown in FIG. 1) and the game servers (as shown in FIG. 1) and the financial server (as show in FIG. 1).

The following functions are performed in each of the boxes showing in FIG. 18 the following symbols are used in the boxes to depict certain activities:

[symbol]

Is an interaction with the financial system [symbol]
Is an activity which can affect the number of tokens in the participants wallet. [symbol]
Indicates a period of time required to synchronise the delivery of a question to different game formats.

### Register

A player will be playing on a client machine as a user player. When the player decides to play a chosen game may first be required to register an interest in the game. This is done through the invocation of the REGISTER process. The act of registration must occur a minimum number of seconds before the game commences. The act of registration may involve the user placing a financial stake—if this is the case the game logic will interface with the financial system in order to gain the necessary permission to withdraw the corresponding funds from the players account. Once registered, the user is required to come back at a later point in time to either CANCEL their registered interest (in effect to deregister from the game) or once the game is due to begin the player is required to JOIN the game.

### Cancel

A player who changes their mind and decides that they no longer wish to play a future game must deregister or cancel their registration in the game. This is done through the invocation of the CANCEL process. The act of cancelling registration must occur a minimum number of seconds before the game commences. Any previously withdrawn financial stake is recredited to the players account through an interface to the financial system at this stage. Once cancelled, a players involvement in logic concerning this game ceases, although subject to time constraints, they may reregister for the same game again should they wish.

### Join

A player with a registered interest in a game may join the game any time after registration closes (after the point at which new players can no longer register). This is done through the invocation of the JOIN process. This process does not advance play logic but sends information to the client that creates the appropriate display on the client screen. After joining a game, the player client is instructed to GO at a certain time.

### Start

Some game types such as open games do not require preregistration. For these games, an alternative combined version of REGISTER and JOIN is provided which is a START process. A player cannot CANCEL their interest in this type of game. After starting a game, the player client is instructed to GO at a certain time.

### Go

Once the game is ready to commence, all clients will simultaneously issue a GO request. The game server(s) ensure that clients issue the GO simultaneously by having previously instructed every client to wait a specified time delay, such that all clients come back at approximately the same time. This will typically be in the final few seconds before a game commences. Once the game is ready to GO, no more players can join, start or register and interest so the game server is able to collate specific statistics for the game (such as number of participating players etc.). After the GO stage, clients then enter the question cycle, beginning with an ASK request for the next available question.

### The Question Cycle (ASK-PLAY-ANSWER-CHECK)

The Question cycle is repeated a number of times—once per question for each available question until the end of the game (or until the player has been eliminated if they do not survive the entire game). In order to enable question synchronisation, the question cycle is split into four separate processes, each of which are described below;

Ask
Whenever the client requires a piece of the question for a game (a question fragment), this is requested within an ASK process. Examples of four question fragments that can be used are: Question Category, Question Subject, Question Text, Possible Answer Choices. Each fragment of the question has a defined time ‘window’ during which the server will release that fragment of the question. If a client requests the question fragment within the expected window, the game server provides that information, if not, then the player is told to come back later (if the fragment is requested too early) or is struck from the game (if the fragment is requested too late.

Play
Some game types may require players to confirm that they wish to progress with the current question. In these cases a PLAY request is required before the next ASK may be issued to retrieve the next fragment of the question. There is a corresponding allowable PLAY time window related directly to the first three question fragments (Category, Subject and Question Text). There is no PLAY request relating to the fourth fragment, as by the time the client has been successfully sent the possible answer choices, the player has no choice but to continue and attempt to answer the question so no corresponding confirmation is required.

Answer

When a player indicates on their screen their selection of an answer to a question (either by electing to pass, or by selecting one of the provided possible answer choices) the client sends an ANSWER request to the server. There is a specific allowable time window related to the ANSWER. In order to avoid any chance of collusion between players, no indication of a correctness of the players answer is released by the server during the answer request.

Check
Once the timeframe for answers has passed, the game server enters a ‘CHECK’ phase, during which clients are allowed to request an update concerning the correctness of their last answer and their current standing within the game (ranking, estimated rewards, token balance etc.). A correctly issued check request will also release information indicating which of the previously provided possible answer choices was the correct answer.

Once the question cycle has been repeated for every available question in a tournament, or the player has been eliminated, the client will enter the closing phase of the game and will issue a CLOSE request.

### Close

The close request may only occur after the game is complete or the user has been eliminated. A successful CLOSE causes the server to interface with the financial system in order to credit the players account with relevant funds (from any winnings or remaining funds for instance). The close will also enable the server to inform the client of the players actual closing status within the game (final rank, actual winnings etc.)

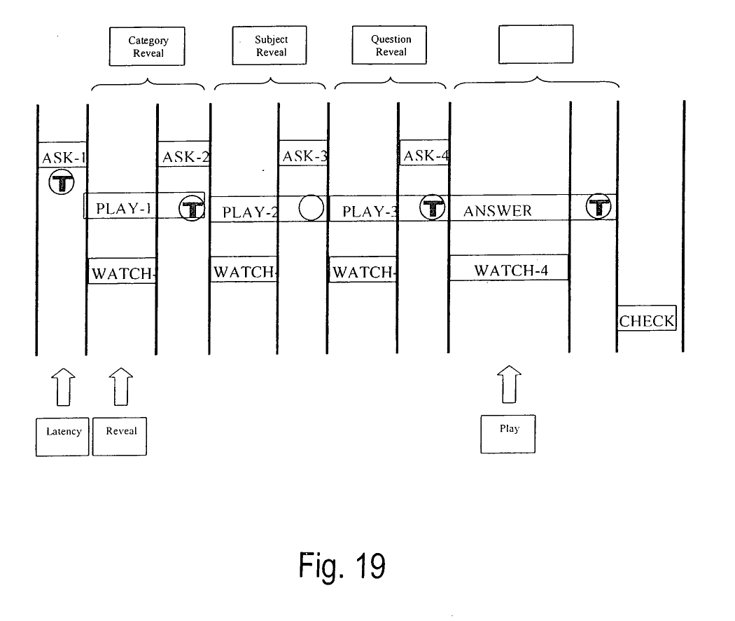

FIG. 19 illustrates the timeline in the development of a single question as is performed in the area within the hatched line of FIG. 18.

The timeline of the activities that takes place in the hatched box of FIG. 18 is illustrated in FIG. 19 which shows the following three global settings which are provided to control timing and logic, to ensure question time-line is consistent across all game types.

Latency—The number of seconds to allow for round-trip network transmission and server processing time. Typically 6 seconds.
Reveal—The number of seconds allocated to allow the player to read the revealed information (category, subject or text of the question) and/or respond if required for the game type. Typically 6 seconds.
Play—The number of seconds allocated to allow the player to select and answer or pass the question (if appropriate). Typically 6 seconds.

With reference to FIG. 19
Category Reveal—will only occur in classic games where questions may be picked from multiple categories. Otherwise, game play will skip directly to the next valid state (e.g. Subject Reveal).
Subject Reveal—will only occur in classic or masters games where questions may be picked from multiple subjects. Otherwise, game play will skip directly to the question but is the only item required on specialist games and tournaments which will occur in all questions.
Choice Reveal—will occur in all questions.

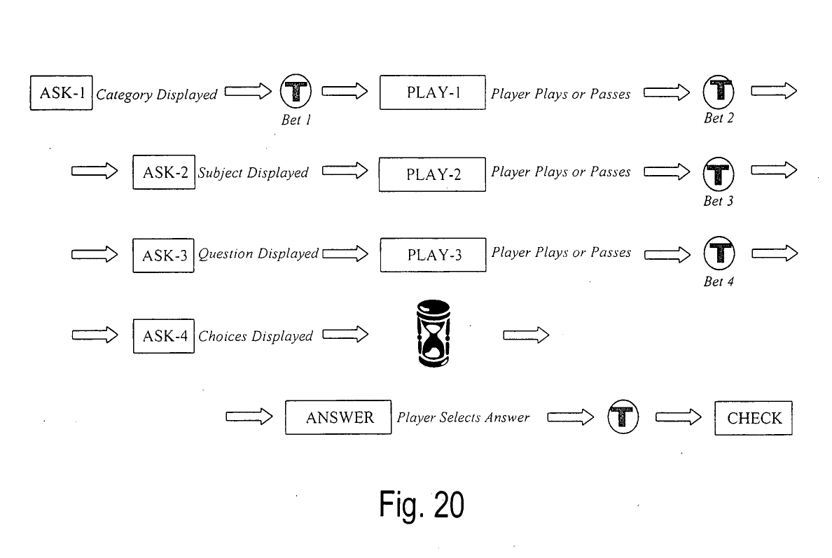

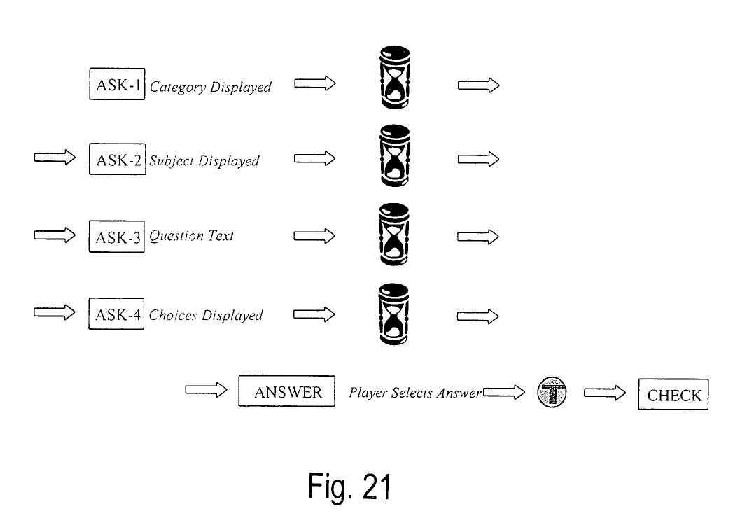

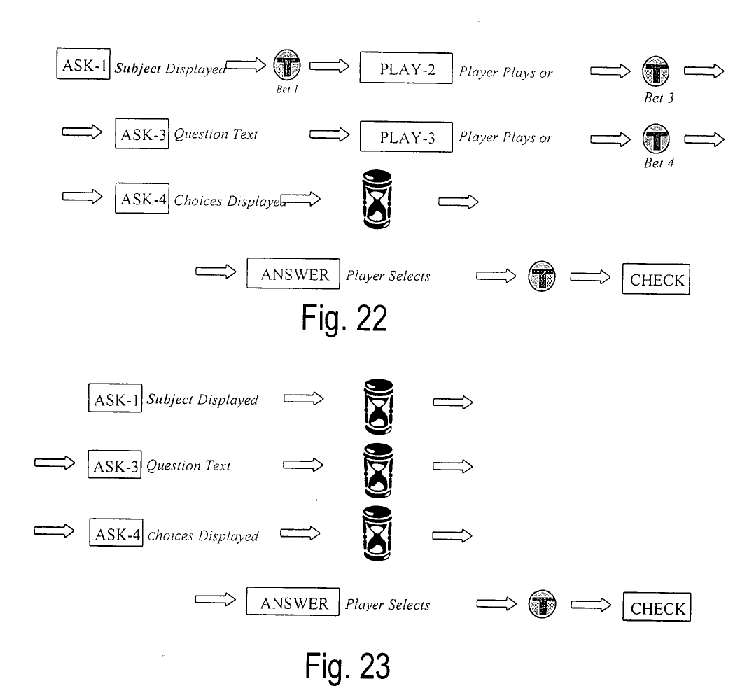

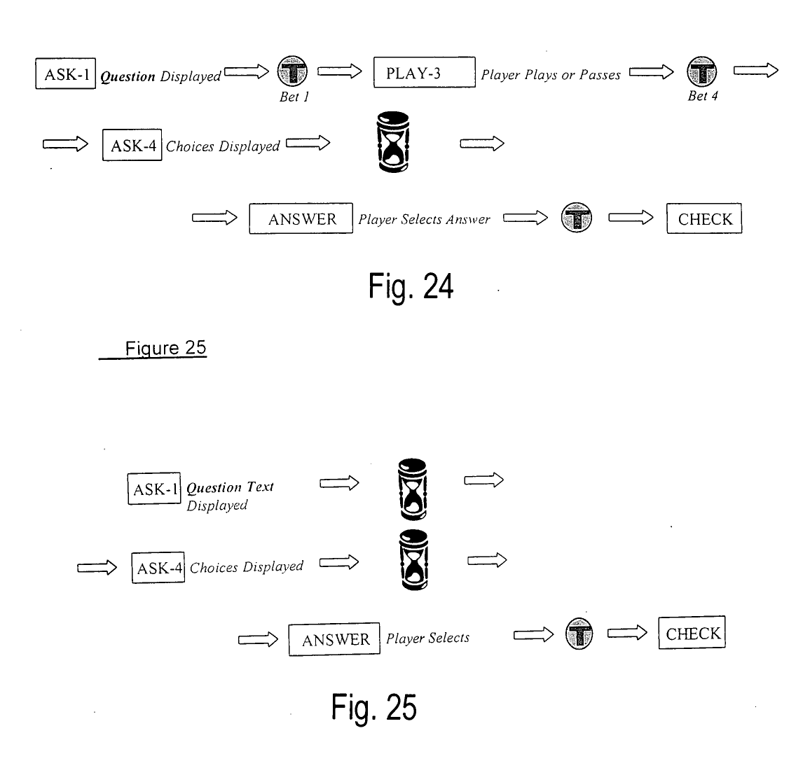

FIGS. 20 to 25 illustrate the sequence that is followed for an open classic game (FIG. 20); a tournament classic game (FIG. 21); an open masters game (FIG. 22); a masters tournament (FIG. 23; a specialist open game (FIG. 24) and a specialist tournament (FIG. 25)

Comparison of FIGS. 20 to 25 shows the different steps required in each game format that are preformed within the hatched area of FIG. 21 in the development of a question. These show how the different formats are synchronised so that open classic games which require category, subject, question and choice of answer to be revealed and open master games which require subject, question and choice of answer to be revealed and open specialist games which require question and choice of answer to be revealed can be synchronised so that the same question is delivered at the same time in each game. They also show how the various tournaments which require question and choice to be revealed because category and subject have been pre-selected can be correlated with the question provision in the various forms of the open game so that the same question is delivered in the tournaments, according to the same chronology as it is delivered in the open games.

In operation of the system of the present invention players may register for a pre-registered game any time before a game commences up to the cut-off time in the “Register” box. This is typically 300 seconds (5 minutes) defined before the game start time, funds may be deducted from the player's wallet at this time.

The register request will credit a player with the ‘opening balance’ of tokens for the game (usually 1000 tokens for a tournament). Players may cancel previous registration for a pre-registered game any time before a game commences as indicated by the “cancel” box up to the defined cut-off time (typically 5 minutes) and appropriate funds are credited to player wallet at this time.

In open games players may come and go as they please and players may attempt to start an open game any time after the cut-off time (typically 12 seconds before open game start time) up to the start of the final question (when it is asked). A start request will deduct the required funds from a player's wallet. This amount will be specified by the player through the client interface.

The start request will credit the user with the number of tokens equivalent to their selected play balance (i.e. if a player elects to join an open game with $50.00 then 5000 token [one token per cent] will be credited to their game token balance.

Players may top-up tokens in play in an open game any time after the maxWait cut-off time (typically 12 seconds before open game start time) up to the start of the final question (when it is first asked). The player must already be playing that open game and the request will deduct the required funds from a player's wallet. This amount will be specified by the player through the client interface.

The following optional features are also illustrated in FIG. 19.

WATCH—The client requests in-game statistics. The request is issued in parallel with player ‘play time’ so that statistics are received by a client shortly after the client has displayed relevant question information to a player.

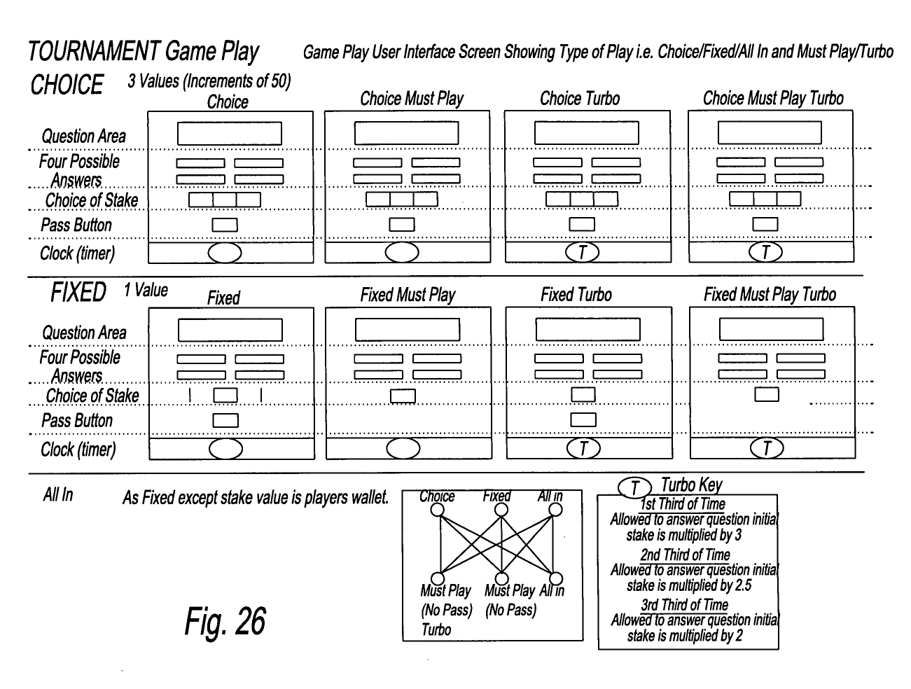

FIG. 26 shows the eight varieties of client interface screen that can be provided to the player to enable a player to play a selected game type with a choice of stake, in this instance the stake may be selected from options displayed on the screen. In this instance three options are provided but there could be more or fewer.

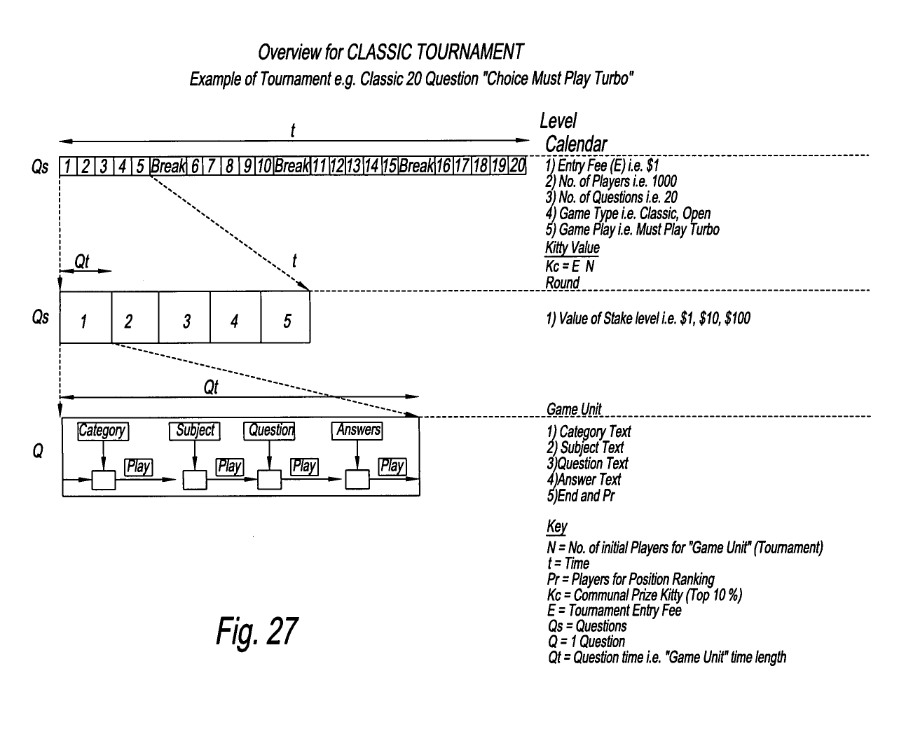

FIG. 27 illustrates the time cycle for the playing of a 20 question classic tournament consisting of four rounds each of which involves answering five questions.

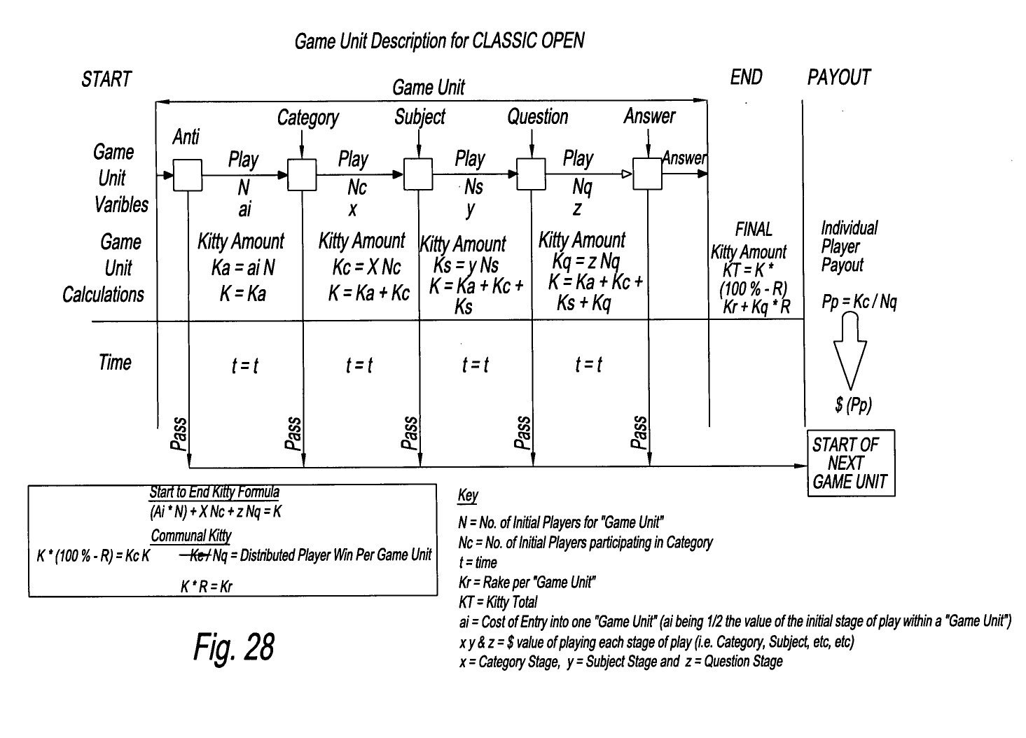

FIG. 28 illustrates the sequence that is followed in a single game unit (question development and response) in a classic open game.

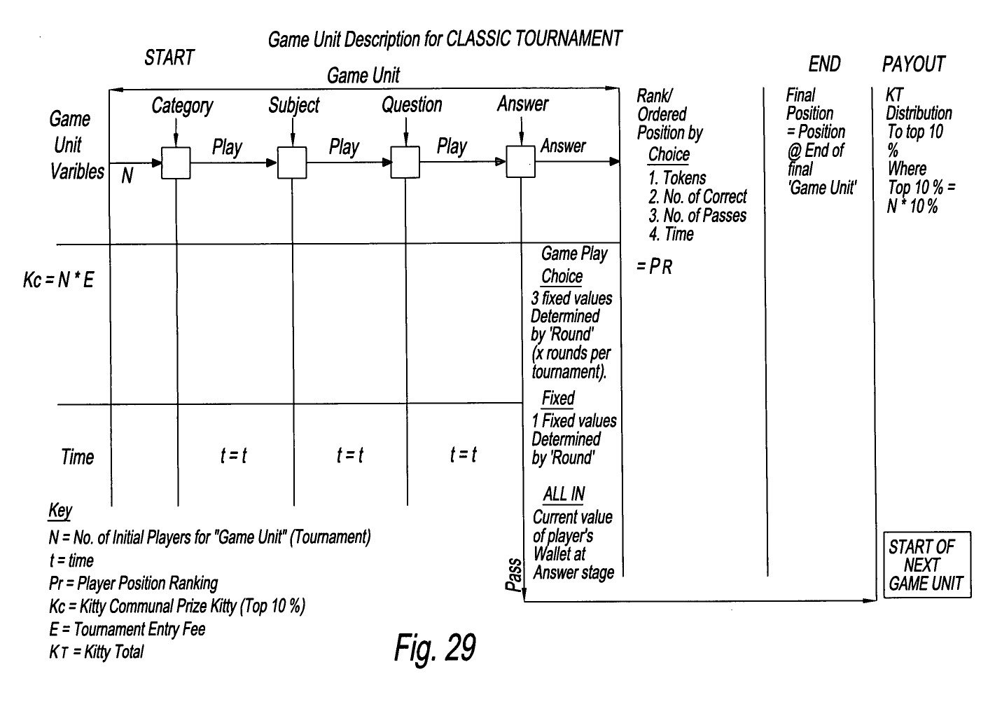

FIG. 29 illustrates the sequence that is followed in a single game unit (question development and response) in a classic tournament game.

1. An on line entertainment system involving one or more servers and client stations for the provision of games whereby the interaction between the player and the game server results in the production of various screen shots on the players display which provide the ability for the player to decide whether to participate in a game and enables the player to select both the nature of the game and method of game play.

2. The on line entertainment system according to claim 1 in which a game comprises one or more multiple choice questions in which the player will be provided on their screen with several possible answers to a question and is provided with the opportunity to attempt to select the correct answer.

3. The on line entertainment system according to claim 1 in which the interaction allows the player to select the nature of the question from a series of categories and/or subjects provided on the players screen.

4. The on line entertainment system according to claim 3 wherein having selected a category and/or subject for the game one or more questions are displayed on the players screen according to the format of game selected and the question is provided on the player's screen together with an indication of the time in which the question should be answered.

5. The on line entertainment system according to claim 1 further comprising a financial system which allows the participant to place a stake on the correctness of their answers to the questions by selecting from staking options provided on the players screen.

6. The on line entertainment system according to claim 5 in which the screen provides the player with the opportunity to select a particular size and type of stake according to the game format and the selected method of play.

7. The on line entertainment system according to claim 1 in which games are operating simultaneously in different formats which are available to players around the world simultaneously.

8. The entertainment system according to any of claim 1 further comprising a tournament.

9. The entertainment system according to any of the preceding claim 1 further comprising a pyramid.

10. The entertainment system according to any of claim 1 comprising an open game.

11. The entertainment system according to any of claim 1 comprising a Teaser.

12. The entertainment system according to claim 2 in which the question provision is synchronised so that one question can be provided to the players on their screen simultaneously in multiple game formats.

13. The entertainment system according to claim 12 in which the question delivery system is programmed to stage and synchronise the steps required for the provision of a question across different game formats.

14. The entertainment system according to claim 2 in which the player is provided on their screen with the following three options on the scope of question:
i) a classic game
ii) a masters game
iii) a specialists game

15. The entertainment system according to any of claim 5 in which the player is provided on line with a staking option selected from.
Fixed Stakes, Fixed Stakes Must Play, Fixed Stakes Must Play Turbo, Fixed Stakes Turbo
Choice Stakes, Choice Stakes Must Play, Choice Stakes Must Play Turbo, Choice Stakes Turbo
All In Stakes, All In Stakes Must Play, All In Stakes Must Play Turbo, All In Stakes Turbo

16. The entertainment system according to claim 5 in which, the financial system and the client interface are integrated so that the staking options are displayed to the player on their screen, tokens are provided to the player from the financial system for staking at the appropriate time according to the game format chosen, the player's rewards and losses from the game are calculated, a financial credit or debit is made to the player's account within the financial system and a report is provided to the player.

17. The entertainment system according to claim 16 in which the financial system provides the following features:
a wallet (or account) for each participant
payment provider integration and
security.

18. The entertainment system according to claim 15 in which the report includes a ranking of relative performance of all the players in the tournament.

19. The entertainment system according to any of claim 5 in which the financial system provides the option to the player to select responsible playing.

20. The entertainment system according to claim 19 in which the option comprises the opportunity for a player to limit the amount of money that is to be placed in account deposits within a defined time-frame.

21. The entertainment system according to claim 1 including the ability to provide ghost participants.

22. The entertainment system according to claim 21 in which ghosts are provided when there are insufficient real participants for a game to proceed.

23. The entertainment system according to claim 21 in which the financial system includes a separate staking system for the ghosts.

24. The entertainment system according to any of claim 21 whereby the ghosts can place selected stakes and will lose whatever is staked if they are incorrect and any rewards they may make are recycled to the ghost financial account to enable further ghost staking.

25. The entertainment system according to claim 24 in which the ghost financial system is non revenue generating.

26. The entertainment system according to any of claim 21 in which each ghost is provided with Artificial Intelligence.

27. The entertainment system according to claim 26 in which the artificial intelligence comprises one or more of the following characteristics:
i) intelligence factor
ii) pass factor
iii) risk factor
iv) speed factor
v) favourite category.
